(19) United States
(12) Patent Application Publication
(10) Pub. No.: US 2026/0167226 A1
(43) Pub. Date: Jun. 18, 2026

(54) Systems and Methods For Emergency Vehicle Detection

(71) Applicant: Aurora Operations, Inc., Pittsburgh, PA (US)

(72) Inventors: Gehua Yang, Mountain View, CA (US); Nilesh Kumar Choubey, Mountain View, CA (US); Zhaoen Su, Pittsburgh, PA (US); Craig C. Bidstrup, Coraopolis, PA (US); Nemanja Djuric, Pittsburgh, PA (US); Meng Fan, Foster City, CA (US); Drew Moses, Pittsburgh, PA (US); Jason L. Owens, Indianola, PA (US)

(21) Appl. No.: 19/127,657

(22) PCT Filed: Nov. 9, 2023
(86) PCT No.: PCT/US2023/037074

§ 371 Date: May 6, 2025

Related U.S. Application Data
(60) Provisional application No. 63/423,997, filed on Nov. 9, 2022.

(51) Int. Cl. B60W 60/00; G06V 10/56; G06V 10/764; G06V 10/82; G06V 20/54; G06V 20/58

(52) U.S. Cl. CPC B60W 60/0015; B60W 60/0027; G06V 10/764; G06V 10/82; G06V 20/54; G06V 20/584; B60W 2420/403; B60W 2554/402; B60W 2554/4045; B60W 2556/10; G06V 10/56; G06V 2201/08

(57) ABSTRACT

Systems and methods for emergency vehicle detection are provided. An example method includes obtaining sensor data including image frames indicative of an actor in an environment of an autonomous vehicle. For a respective image frame, the example, method includes determining, using a machine-learned model, that the actor is an emergency vehicle and generating output data indicating that the emergency vehicle is active or inactive. The example method includes storing (e.g., in a buffer) attribute data for the respective image frame. The attribute data includes the output data and a time associated with the respective image frame. Once the buffer reaches a particular threshold, the example method includes determining (e.g., using a second model) that the emergency vehicle is an active emergency vehicle based on the attribute data. The example method includes performing an action for the autonomous vehicle based on the active emergency vehicle being within the autonomous vehicle's environment.

### RELATED APPLICATIONS

This application claims the benefit of and the priority to U.S. Provisional Patent Application No. 63/423,997, filed Nov. 9, 2022. U.S. Provisional Patent Application No. 63/423,997 is hereby incorporated by reference in its entirety.

### BACKGROUND

An autonomous platform can process data to perceive an environment through which the autonomous platform can travel. For example, an autonomous vehicle can perceive its environment using a variety of sensors and identify objects around the autonomous vehicle. The autonomous vehicle can identify an appropriate path through the perceived surrounding environment and navigate along the path with minimal or no human input.

### SUMMARY

The present disclosure is directed to techniques for detecting active emergency vehicles within the environment of an autonomous vehicle. Detection techniques according to the present disclosure can provide an improved image-based assessment of traffic actors using a combination of models to granularly evaluate actors on a per frame level, while also detecting whether the actors are active emergency vehicles given historical context across multiple frames.

For example, a perception system of an autonomous vehicle can perceive its environment by obtaining sensor data indicative of the vehicle's surroundings. The sensor data can be captured over time and can include a plurality of image frames depicting an actor within the vehicle's environment.

The autonomous vehicle can utilize the sensor data to determine that the actor is an emergency vehicle. For example, a machine-learned model (e.g., a convolutional neural network with a ResNet-18 backbone) can analyze a respective image frame to detect whether or not the actor depicted in the image frame is an emergency vehicle. Example emergency vehicles can include: a police car, an ambulance, a fire truck, a tow truck, etc. Actors that are identified as not representing an emergency vehicle can be categorized as a “non-emergency vehicle” and can be filtered out of the downstream analysis.

If the actor is an emergency vehicle, the machine-learned model can also determine whether the emergency vehicle is in an active or inactive state. The machine-learned model can be trained to determine whether an emergency vehicle is active or inactive by detecting whether a bulb of a particular light on the emergency vehicle (e.g., a roof-mounted beacon) is in an “on” state or an “off” state in the respective image frame. An emergency vehicle with a bulb in an “on” state can be considered active, while an emergency vehicle with a bulb in an “off” state can be considered inactive. Based on this analysis, the machine-learned model can generate output data indicating that the actor within the respective image frame is an emergency vehicle in an active state or an inactive state.

A buffer can store attribute data that includes the output data from the machine-learned model. For example, the attribute data can include the output data with an associated time (e.g., when the respective image frame was captured). The buffer can continue to store attribute data for each of the image frames as they are processed by the machine-learned model.

Once the buffer accumulates a threshold number of image frames across a plurality of times, a second model can analyze the number of image frames. For instance, the second model (e.g., a rules-based smoother model) can process the image frames to determine whether greater than 50% of the processed image frames indicate that the emergency vehicle is in the active state. If so, the second model can be configured to determine that the emergency vehicle is an active emergency vehicle and generate an output regarding the same. In some examples, the second model can evaluate a pattern, a color, an intensity, etc. within the image frames to help improve its confidence that an active emergency vehicle is present.

Additionally, or alternatively, according to the present disclosure the autonomous vehicle can include a machine-learned signal indicator model. The signal indicator model can be trained to analyze a plurality of image frames to inform its determination as to whether an actor's signal indicator (e.g., turn signal, brake light, etc.) is in an active state or an inactive state. For example, this can include processing a current image frame with historic image frames at previous timesteps to detect a pattern indicating that the signal indicator is flashing, etc. As will be further described herein, the output from the signal indicator can be post-processed in a manner similar to, or different from, the emergency vehicle model.

The autonomous vehicle can perform various actions based on the detection of an active emergency vehicle and/or the detection of an actor's active signal indicator within the vehicle's surroundings. For example, the autonomous vehicle can forecast the motion of the active emergency vehicle or other actor (e.g., with an activated left turn signal) to predict its future trajectory. Moreover, the vehicle's motion planning system can strategize about how to interact with and traverse the environment by considering its decision-level options for movement (e.g., yield/not yield for the emergency vehicle/actor, etc.). If necessary, the autonomous vehicle can be controlled to physically maneuver in response to the active emergency vehicle (e.g., to pull to the shoulder) or actor (e.g., to allow the actor to merge).

The two-stage detection techniques of the present disclosure can provide a number of technical improvements for the performance of autonomous vehicles. For instance, by evaluating actors for emergency vehicle status using the described two-stage approach, the autonomous vehicle is able to properly dedicate its onboard computing resources to more discrete tasks at each stage. For example, the machine-learn model can focus on the task of image processing and classification, without concern on temporal analysis, while the second/smoother model can focus on the aggregated result across a plurality of timesteps. This helps to reduce the complexity of training or building heuristics for the models. Furthermore, the described detection techniques allow an autonomous vehicle to identify/classify active emergency vehicles in its surroundings with higher accuracy, while also improving the autonomous vehicle's motion response.

For example, in an aspect, the present disclosure provides an example method for detecting emergency vehicles for an autonomous vehicle. In some implementations, the example computer-implemented method includes (a) obtaining sensor data including a plurality of image frames indicative of an actor in an environment of an autonomous vehicle. In some implementations, the example method includes (b) for a respective image frame: (i) determining, using a machine-learned model, that the actor is an emergency vehicle, (ii) generating, using the machine-learned model, output data indicating that the emergency vehicle is in an active state or an inactive state in the respective image frame, and (iii) storing attribute data for the respective image frame. The attribute data includes the output data of the machine-learned model and a time associated with the respective image frame. In some implementations, the example method includes (c) determining, based on the output data associated with the respective image frame, that the emergency vehicle is an active emergency vehicle. In some implementations, the example method includes (d) performing an action for the autonomous vehicle based on the active emergency vehicle being within the environment of the autonomous vehicle.

In some implementations of the example method, (b)(ii) includes: determining, using the machine-learned model, a state of a light of the emergency vehicle in the respective image frame, wherein the state of the light includes an on state or an off state; and determining, using the machine-learned model, that the emergency vehicle is in the active state or the inactive state for the respective image frame based on the state of the light.

In some implementations of the example method, (b)(i) includes determining, using the machine-learned model, a category of the emergency vehicle from among one of the following categories: (1) a police car; (2) an ambulance; (3) a fire truck; or (4) a tow truck.

In some implementations of the example method, the output data is indicative of a category of the emergency vehicle.

In some implementations of the example method, (b)(i) includes: obtaining track data for the actor within the environment the autonomous vehicle, the track data being indicative of a bounding shape of the actor; determining that a centroid of the bounding shape is within a projected field of view of the autonomous vehicle; and in response to determining the centroid of the bounding shape is within the projected field of view, generating input data for the machine-learned model based on the sensor data.

In some implementations of the example method, the output data further includes track data associated with the emergency vehicle.

In some implementations of the example method, (b)(iii) includes storing the attribute data in a buffer, and wherein the method further includes: determining that the buffer includes a threshold amount of attribute data for a plurality of image frames at a plurality of times; and determining, using a second model, that the emergency vehicle is an active emergency vehicle based on the attribute data for at least a subset of the plurality of image frames.

In some implementations of the example method, (c) includes: determining, using the second model, at least one of the following: (1) a pattern of a light of the emergency vehicle; (2) a color of the light of the emergency vehicle; or (3) an intensity of the light of the emergency vehicle.

In some implementations of the example method, the machine-learned model is trained based on labeled training data, wherein the labeled training data is based on point cloud data and image data, and wherein the labeled training data is indicative of a plurality of training actors, a respective training actor being labelled with an emergency vehicle label.

In some implementations of the example method, the emergency vehicle label indicates a type of emergency vehicle of the respective training actor or that the training actor is not an emergency vehicle.

In some implementations of the example method, the respective training actor includes an activity label indicating that the respective training actor is in an active state or an inactive state based on a light of the training actor.

In some implementations of the example method, the machine-learned model is a convolutional neural network.

In some implementations of the example method, the second model is a rules-based smoothing model.

In some implementations of the example method, the action by the autonomous vehicle includes at least one of: (1) forecasting a motion of the active emergency vehicle; (2) generating a motion plan for the autonomous vehicle; or (3) controlling a motion of the autonomous vehicle.

In some implementations of the example method, (b)(iii) includes storing, in a buffer, the attribute data for the respective image frame, the attribute data including the output data of the machine-learned model and the time associated with the respective image frame, and (c) includes determining that the buffer includes the threshold amount of attribute data for the plurality of image frames at the plurality of times.

In some implementations of the example method, the machine-learned model is further configured to process one or more historical image frames to generate the output data, the one or more historical image frames being associated with one or more timesteps that are previous to a timestep associated with the respective time frame.

For example, in an aspect, the present disclosure provides for one or more example non-transitory computer-readable media storing instructions that are executable to cause one or more processors to perform operations. In some implementations, the operations include (a) obtaining sensor data including a plurality of image frames indicative of an actor in an environment of an autonomous vehicle. The operations include (b) for a respective image frame, (i) determining, using a machine-learned model, that the actor is an emergency vehicle, (ii) generating, using the machine-learned model, output data indicating that the emergency vehicle is in an active state or an inactive state in the respective image frame, and (iii) storing attribute data for the respective image frame, the attribute data including the output data of the machine-learned model and a time associated with the respective image frame. In some implementations, the operations include determining, based on the output data associated with the respective image frame, that the emergency vehicle is an active emergency vehicle. In some implementations, the operations include performing an action for the autonomous vehicle based on the active emergency vehicle being within the environment of the autonomous vehicle.

In some implementations of the example one or more non-transitory computer readable media, (b)(ii), includes: determining, using the machine-learned model, a state of a light of the emergency vehicle in the respective image frame, wherein the state of the light includes an on state or an off state; and determining, using the machine-learned model, that the emergency vehicle is in the active state or the inactive state for the respective image frame based on the state of the light.

In some implementations of the example one or more non-transitory computer readable media, the output data is indicative of a category of the emergency vehicle.

In some implementations of the example one or more non-transitory computer readable media, (b)(i) includes: obtaining track data for the actor within the environment of the autonomous vehicle, the track data being indicative of a bounding shape of the actor; determining that a centroid of the bounding shape is within a projected field of view of the autonomous vehicle; and in response to determining the centroid of the bounding shape is within the projected field of view, generating input data for the machine-learned model based on the sensor data.

For example, in an aspect, the present disclosure provides an example autonomous vehicle control system for controlling an autonomous vehicle. In some implementations, the example autonomous vehicle control system includes one or more processors and one or more non-transitory computer-readable media storing instructions that are executable by the one or more processors to cause the autonomous vehicle control system to control a motion of the autonomous vehicle using an operational system. In some implementations, the operational system detected an emergency vehicle by (a) obtaining sensor data including a plurality of image frames indicative of an actor in an environment of the autonomous vehicle; (b) for a respective image frame, (i) determining, using a machine-learned model, that the actor is the emergency vehicle, (ii) generating, using the machine-learned model, output data indicating that the emergency vehicle is in an active state or an inactive state in the respective image frame, and (iii) storing attribute data for the respective image frame, the attribute data including the output data of the machine-learned model and a time associated with the respective image frame; and (c) determining, based on the output data associated with the respective image frame, that the emergency vehicle is an active emergency vehicle.

In some implementations of the example autonomous vehicle control system, (b)(iii) includes storing the attribute data in a buffer. In some implementations, the operational system further detected the emergency vehicle by determining that the buffer includes a threshold amount of attribute data for a plurality of image frames at a plurality of times; and determining, using a second model, that the emergency vehicle is an active emergency vehicle based on the attribute data for at least a subset of the plurality of image frames.

Other example aspects of the present disclosure are directed to other systems, methods, vehicles, apparatuses, tangible non-transitory computer-readable media, and devices for performing functions described herein. These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 is a block diagram of an example operational scenario, according to some implementations of the present disclosure;

FIG. 2 is a block diagram of an example system, according to some implementations of the present disclosure;

FIG. 3A is a representation of an example operational environment, according to some implementations of the present disclosure;

FIG. 3B is a representation of an example map of an operational environment, according to some implementations of the present disclosure;

FIG. 3C is a representation of an example operational environment, according to some implementations of the present disclosure;

FIG. 3D is a representation of an example map of an operational environment, according to some implementations of the present disclosure;

FIG. 4 is a block diagram of an example computing system for detecting emergency vehicles, according to some implementations of the present disclosure;

FIG. 5A is a block diagram of an example computing system for pre-processing image frames, according to some implementations of the present disclosure.

FIG. 5B presents block diagrams of an example model architectures for training and analyzing actor signal indicators, according to some implementations of the present disclosure.

FIGS. 6A-1-4 are example vehicles, according to some implementations of the present disclosure.

FIG. 6B is a representation of example vehicle maneuvers, according to some implementations of the present disclosure.

FIG. 6C is a representation of example training data, according to some implementations of the present disclosure.

FIG. 7 is a flow chart of an example method for detecting emergency vehicles, according to some implementations of the present disclosure.

FIG. 8A is a flow chart of an example method for detecting emergency vehicles using a pre-processing module, according to some implementations of the present disclosure.

FIG. 8B is a flow chart of an example method for detecting emergency vehicles using a machine-learned model, according to some implementations of the present disclosure.

FIG. 9 is a flowchart of an example method for training and validating one or more models, according to some implementations of the present disclosure;

FIG. 10 is a flowchart of an example method for detecting signal indicators and controlling an autonomous vehicle, according to some implementations of the present disclosure; and

FIG. 11 is a block diagram of an example computing system for performing system validation, according to some implementations of the present disclosure.

### DETAILED DESCRIPTION

The following describes the technology of this disclosure within the context of an autonomous vehicle for example purposes only. As described herein, the technology described herein is not limited to an autonomous vehicle and can be implemented for or within other autonomous platforms and other computing systems.

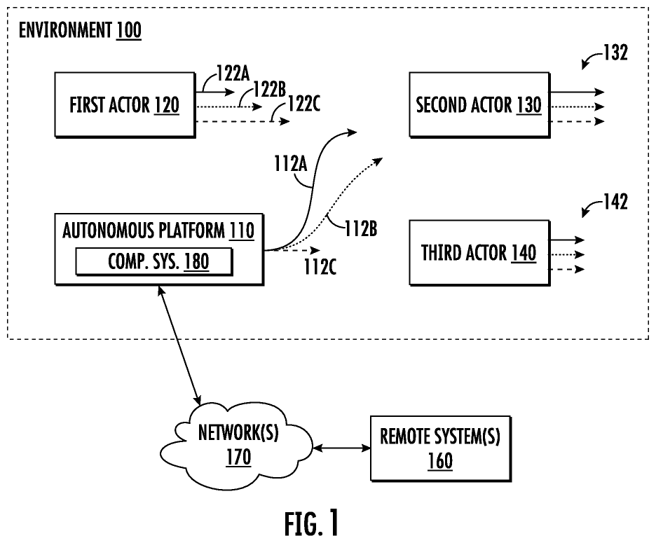

With reference to FIGS. 1-11, example embodiments of the present disclosure are discussed in further detail. FIG. 1 is a block diagram of an example operational scenario according to example implementations of the present disclosure. In the example operational scenario, an environment 100 contains an autonomous platform 110 and a number of objects, including first actor 120, second actor 130, and third actor 140. In the example operational scenario, the autonomous platform 110 can move through the environment 100 and interact with the object(s) that are located within the environment 100 (e.g., first actor 120, second actor 130, third actor 140, etc.). The autonomous platform 110 can optionally be configured to communicate with remote system(s) 160 through network(s) 170.

The environment 100 may be or include an indoor environment (e.g., within one or more facilities, etc.) or an outdoor environment. An indoor environment, for example, may be an environment enclosed by a structure such as a building (e.g., a service depot, maintenance location, manufacturing facility, etc.). An outdoor environment, for example, may be one or more areas in the outside world such as, for example, one or more rural areas (e.g., with one or more rural travel ways, etc.), one or more urban areas (e.g., with one or more city travel ways, highways, etc.), one or more suburban areas (e.g., with one or more suburban travel ways, etc.), or other outdoor environments.

The autonomous platform 110 may be any type of platform configured to operate within the environment 100. For example, the autonomous platform 110 may be a vehicle configured to autonomously perceive and operate within the environment 100. The vehicles may be a ground-based autonomous vehicle such as, for example, an autonomous car, truck, van, etc. The autonomous platform 110 may be an autonomous vehicle that can control, be connected to, or be otherwise associated with implements, attachments, and/or accessories for transporting people or cargo. This can include, for example, an autonomous tractor optionally coupled to a cargo trailer. Additionally or alternatively, the autonomous platform 110 may be any other type of vehicle such as one or more aerial vehicles, water-based vehicles, space-based vehicles, other ground-based vehicles, etc.

The autonomous platform 110 may be configured to communicate with the remote system(s) 160. For instance, the remote system(s) 160 can communicate with the autonomous platform 110 for assistance (e.g., navigation assistance, situation response assistance, etc.), control (e.g., fleet management, remote operation, etc.), maintenance (e.g., updates, monitoring, etc.), or other local or remote tasks. In some implementations, the remote system(s) 160 can provide data indicating tasks that the autonomous platform 110 should perform. For example, as further described herein, the remote system(s) 160 can provide data indicating that the autonomous platform 110 is to perform a trip/service such as a user transportation trip/service, delivery trip/service (e.g., for cargo, freight, items), etc.

The autonomous platform 110 can communicate with the remote system(s) 160 using the network(s) 170. The network(s) 170 can facilitate the transmission of signals (e.g., electronic signals, etc.) or data (e.g., data from a computing device, etc.) and can include any combination of various wired (e.g., twisted pair cable, etc.) or wireless communication mechanisms (e.g., cellular, wireless, satellite, microwave, radio frequency, etc.) or any desired network topology (or topologies). For example, the network(s) 170 can include a local area network (e.g., intranet, etc.), a wide area network (e.g., the Internet, etc.), a wireless LAN network (e.g., through Wi-Fi, etc.), a cellular network, a SATCOM network, a VHF network, a HF network, a WiMAX based network, or any other suitable communications network (or combination thereof) for transmitting data to or from the autonomous platform 110.

As shown for example in FIG. 1, the environment 100 can include one or more objects. The object(s) may be objects not in motion or not predicted to move (“static objects”) or object(s) in motion or predicted to be in motion (“dynamic objects” or “actors”). In some implementations, the environment 100 can include any number of actor(s) such as, for example, one or more pedestrians, animals, vehicles, etc. The actor(s) can move within the environment according to one or more actor trajectories. For instance, the first actor 120 can move along any one of the first actor trajectories 122A-C, the second actor 130 can move along any one of the second actor trajectories 132, the third actor 140 can move along any one of the third actor trajectories 142, etc.

As further described herein, the autonomous platform 110 can utilize its autonomy system(s) to detect these actors (and their movement) and plan its motion to navigate through the environment 100 according to one or more platform trajectories 112A-C. The autonomous platform 110 can include onboard computing system(s) 180. The onboard computing system(s) 180 can include one or more processors and one or more memory devices. The one or more memory devices can store instructions executable by the one or more processors to cause the one or more processors to perform operations or functions associated with the autonomous platform 110, including implementing its autonomy system(s).

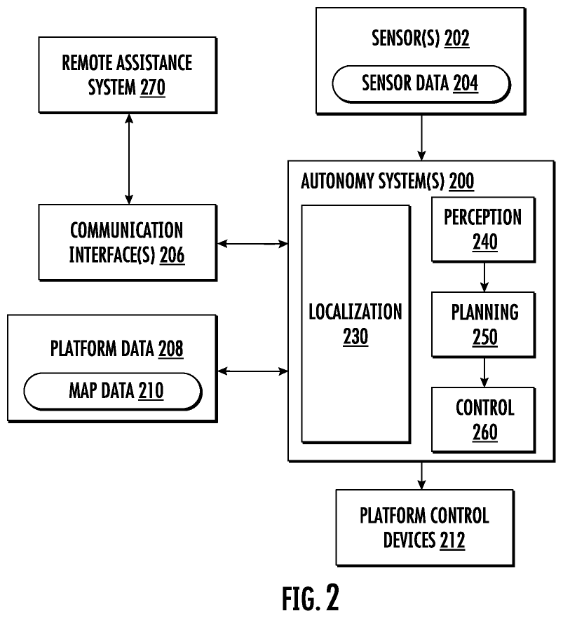

FIG. 2 is a block diagram of an example autonomy system 200 for an autonomous platform, according to some implementations of the present disclosure. In some implementations, the autonomy system 200 can be implemented by a computing system of the autonomous platform (e.g., the onboard computing system(s) 180 of the autonomous platform 110). The autonomy system 200 can operate to obtain inputs from sensor(s) 202 or other input devices. In some implementations, the autonomy system 200 can additionally obtain platform data 208 (e.g., map data 210) from local or remote storage. The autonomy system 200 can generate control outputs for controlling the autonomous platform (e.g., through platform control devices 212, etc.) based on sensor data 204, map data 210, or other data. The autonomy system 200 may include different subsystems for performing various autonomy operations. The subsystems may include a localization system 230, a perception system 240, a planning system 250, and a control system 260. The localization system 230 can determine the location of the autonomous platform within its environment; the perception system 240 can detect, classify, and track objects and actors in the environment; the planning system 250 can determine a trajectory for the autonomous platform; and the control system 260 can translate the trajectory into vehicle controls for controlling the autonomous platform. The autonomy system 200 can be implemented by one or more onboard computing system(s). The subsystems can include one or more processors and one or more memory devices. The one or more memory devices can store instructions executable by the one or more processors to cause the one or more processors to perform operations or functions associated with the subsystems. The computing resources of the autonomy system 200 can be shared among its subsystems, or a subsystem can have a set of dedicated computing resources.

In some implementations, the autonomy system 200 can be implemented for or by an autonomous vehicle (e.g., a ground-based autonomous vehicle). The autonomy system 200 can perform various processing techniques on inputs (e.g., the sensor data 204, the map data 210) to perceive and understand the vehicle's surrounding environment and generate an appropriate set of control outputs to implement a vehicle motion plan (e.g., including one or more trajectories) for traversing the vehicle's surrounding environment (e.g., environment 100 of FIG. 1, etc.). In some implementations, an autonomous vehicle implementing the autonomy system 200 can drive, navigate, operate, etc. with minimal or no interaction from a human operator (e.g., driver, pilot, etc.).

In some implementations, the autonomous platform can be configured to operate in a plurality of operating modes. For instance, the autonomous platform can be configured to operate in a fully autonomous (e.g., self-driving, etc.) operating mode in which the autonomous platform is controllable without user input (e.g., can drive and navigate with no input from a human operator present in the autonomous vehicle or remote from the autonomous vehicle, etc.). The autonomous platform can operate in a semi-autonomous operating mode in which the autonomous platform can operate with some input from a human operator present in the autonomous platform (or a human operator that is remote from the autonomous platform). In some implementations, the autonomous platform can enter into a manual operating mode in which the autonomous platform is fully controllable by a human operator (e.g., human driver, etc.) and can be prohibited or disabled (e.g., temporary, permanently, etc.) from performing autonomous navigation (e.g., autonomous driving, etc.). The autonomous platform can be configured to operate in other modes such as, for example, park or sleep modes (e.g., for use between tasks such as waiting to provide a trip/service, recharging, etc.). In some implementations, the autonomous platform can implement vehicle operating assistance technology (e.g., collision mitigation system, power assist steering, etc.), for example, to help assist the human operator of the autonomous platform (e.g., while in a manual mode, etc.).

The autonomy system 200 can be located onboard (e.g., on or within) an autonomous platform and can be configured to operate the autonomous platform in various environments. The environment may be a real-world environment or a simulated environment. In some implementations, one or more simulation computing devices can simulate one or more of: the sensors 202, the sensor data 204, communication interface(s) 206, the platform data 208, or the platform control devices 212 for simulating operation of the autonomy system 200.

In some implementations, the autonomy system 200 can communicate with one or more networks or other systems with the communication interface(s) 206. The communication interface(s) 206 can include any suitable components for interfacing with one or more network(s) (e.g., the network(s) 170 of FIG. 1, etc.), including, for example, transmitters, receivers, ports, controllers, antennas, or other suitable components that can help facilitate communication. In some implementations, the communication interface(s) 206 can include a plurality of components (e.g., antennas, transmitters, or receivers, etc.) that allow it to implement and utilize various communication techniques (e.g., multiple-input, multiple-output (MIMO) technology, etc.).

In some implementations, the autonomy system 200 can use the communication interface(s) 206 to communicate with one or more computing devices that are remote from the autonomous platform (e.g., the remote system(s) 160) over one or more network(s) (e.g., the network(s) 170). For instance, in some examples, one or more inputs, data, or functionalities of the autonomy system 200 can be supplemented or substituted by a remote system communicating over the communication interface(s) 206. For instance, in some implementations, the map data 210 can be downloaded over a network to a remote system using the communication interface(s) 206. In some examples, one or more of the localization system 230, the perception system 240, the planning system 250, or the control system 260 can be updated, influenced, nudged, communicated with, etc. by a remote system for assistance, maintenance, situational response override, management, etc.

The sensor(s) 202 can be located onboard the autonomous platform. In some implementations, the sensor(s) 202 can include one or more types of sensor(s). For instance, one or more sensors can include image capturing device(s) (e.g., visible spectrum cameras, infrared cameras, etc.). Additionally or alternatively, the sensor(s) 202 can include one or more depth capturing device(s). For example, the sensor(s) 202 can include one or more Light Detection and Ranging (LIDAR) sensor(s) or Radio Detection and Ranging (RADAR) sensor(s). The sensor(s) 202 can be configured to generate point data descriptive of at least a portion of a three-hundred-and-sixty-degree view of the surrounding environment. The point data can be point cloud data (e.g., three-dimensional LIDAR point cloud data, RADAR point cloud data). In some implementations, one or more of the sensor(s) 202 for capturing depth information can be fixed to a rotational device in order to rotate the sensor(s) 202 about an axis. The sensor(s) 202 can be rotated about the axis while capturing data in interval sector packets descriptive of different portions of a three-hundred-and-sixty-degree view of a surrounding environment of the autonomous platform. In some implementations, one or more of the sensor(s) 202 for capturing depth information can be solid state.

The sensor(s) 202 can be configured to capture the sensor data 204 indicating or otherwise being associated with at least a portion of the environment of the autonomous platform. The sensor data 204 can include image data (e.g., 2D camera data, video data, etc.), RADAR data, LIDAR data (e.g., 3D point cloud data, etc.), audio data, or other types of data. In some implementations, the autonomy system 200 can obtain input from additional types of sensors, such as inertial measurement units (IMUs), altimeters, inclinometers, odometry devices, location or positioning devices (e.g., GPS, compass), wheel encoders, or other types of sensors. In some implementations, the autonomy system 200 can obtain sensor data 204 associated with particular component(s) or system(s) of an autonomous platform. This sensor data 204 can indicate, for example, wheel speed, component temperatures, steering angle, cargo or passenger status, etc. In some implementations, the autonomy system 200 can obtain sensor data 204 associated with ambient conditions, such as environmental or weather conditions. In some implementations, the sensor data 204 can include multi-modal sensor data. The multi-modal sensor data can be obtained by at least two different types of sensor(s) (e.g., of the sensors 202) and can indicate static object(s) or actor(s) within an environment of the autonomous platform. The multi-modal sensor data can include at least two types of sensor data (e.g., camera and LIDAR data). In some implementations, the autonomous platform can utilize the sensor data 204 for sensors that are remote from (e.g., offboard) the autonomous platform. This can include for example, sensor data 204 captured by a different autonomous platform.

The autonomy system 200 can obtain the map data 210 associated with an environment in which the autonomous platform was, is, or will be located. The map data 210 can provide information about an environment or a geographic area. For example, the map data 210 can provide information regarding the identity and location of different travel ways (e.g., roadways, etc.), travel way segments (e.g., road segments, etc.), buildings, or other items or objects (e.g., lampposts, crosswalks, curbs, etc.); the location and directions of boundaries or boundary markings (e.g., the location and direction of traffic lanes, parking lanes, turning lanes, bicycle lanes, other lanes, etc.); traffic control data (e.g., the location and instructions of signage, traffic lights, other traffic control devices, etc.); obstruction information (e.g., temporary or permanent blockages, etc.); event data (e.g., road closures/traffic rule alterations due to parades, concerts, sporting events, etc.); nominal vehicle path data (e.g., indicating an ideal vehicle path such as along the center of a certain lane, etc.); or any other map data that provides information that assists an autonomous platform in understanding its surrounding environment and its relationship thereto. In some implementations, the map data 210 can include high-definition map information. Additionally or alternatively, the map data 210 can include sparse map data (e.g., lane graphs, etc.). In some implementations, the sensor data 204 can be fused with or used to update the map data 210 in real-time.

The autonomy system 200 can include the localization system 230, which can provide an autonomous platform with an understanding of its location and orientation in an environment. In some examples, the localization system 230 can support one or more other subsystems of the autonomy system 200, such as by providing a unified local reference frame for performing, e.g., perception operations, planning operations, or control operations.

In some implementations, the localization system 230 can determine a current position of the autonomous platform. A current position can include a global position (e.g., respecting a georeferenced anchor, etc.) or relative position (e.g., respecting objects in the environment, etc.). The localization system 230 can generally include or interface with any device or circuitry for analyzing a position or change in position of an autonomous platform (e.g., autonomous ground-based vehicle, etc.). For example, the localization system 230 can determine position by using one or more of: inertial sensors (e.g., inertial measurement unit(s), etc.), a satellite positioning system, radio receivers, networking devices (e.g., based on IP address, etc.), triangulation or proximity to network access points or other network components (e.g., cellular towers, Wi-Fi access points, etc.), or other suitable techniques. The position of the autonomous platform can be used by various subsystems of the autonomy system 200 or provided to a remote computing system (e.g., using the communication interface(s) 206).

In some implementations, the localization system 230 can register relative positions of elements of a surrounding environment of an autonomous platform with recorded positions in the map data 210. For instance, the localization system 230 can process the sensor data 204 (e.g., LIDAR data, RADAR data, camera data, etc.) for aligning or otherwise registering to a map of the surrounding environment (e.g., from the map data 210) to understand the autonomous platform's position within that environment. Accordingly, in some implementations, the autonomous platform can identify its position within the surrounding environment (e.g., across six axes, etc.) based on a search over the map data 210. In some implementations, given an initial location, the localization system 230 can update the autonomous platform's location with incremental re-alignment based on recorded or estimated deviations from the initial location. In some implementations, a position can be registered directly within the map data 210.

In some implementations, the map data 210 can include a large volume of data subdivided into geographic tiles, such that a desired region of a map stored in the map data 210 can be reconstructed from one or more tiles. For instance, a plurality of tiles selected from the map data 210 can be stitched together by the autonomy system 200 based on a position obtained by the localization system 230 (e.g., a number of tiles selected in the vicinity of the position).

In some implementations, the localization system 230 can determine positions (e.g., relative or absolute) of one or more attachments or accessories for an autonomous platform. For instance, an autonomous platform can be associated with a cargo platform, and the localization system 230 can provide positions of one or more points on the cargo platform. For example, a cargo platform can include a trailer or other device towed or otherwise attached to or manipulated by an autonomous platform, and the localization system 230 can provide for data describing the position (e.g., absolute, relative, etc.) of the autonomous platform as well as the cargo platform. Such information can be obtained by the other autonomy systems to help operate the autonomous platform.

The autonomy system 200 can include the perception system 240, which can allow an autonomous platform to detect, classify, and track objects and actors in its environment. Environmental features or objects perceived within an environment can be those within the field of view of the sensor(s) 202 or predicted to be occluded from the sensor(s) 202. This can include object(s) not in motion or not predicted to move (static objects) or object(s) in motion or predicted to be in motion (dynamic objects/actors).

The perception system 240 can determine one or more states (e.g., current or past state(s), etc.) of one or more objects that are within a surrounding environment of an autonomous platform. For example, state(s) can describe (e.g., for a given time, time period, etc.) an estimate of an object's current or past location (also referred to as position); current or past speed/velocity; current or past acceleration; current or past heading; current or past orientation; size/footprint (e.g., as represented by a bounding shape, object highlighting, etc.); classification (e.g., pedestrian class vs. vehicle class vs. bicycle class, etc.); the uncertainties associated therewith; or other state information. In some implementations, the perception system 240 can determine the state(s) using one or more algorithms or machine-learned models configured to identify/classify objects based on inputs from the sensor(s) 202. The perception system can use different modalities of the sensor data 204 to generate a representation of the environment to be processed by the one or more algorithms or machine-learned models. In some implementations, state(s) for one or more identified or unidentified objects can be maintained and updated over time as the autonomous platform continues to perceive or interact with the objects (e.g., maneuver with or around, yield to, etc.). In this manner, the perception system 240 can provide an understanding about a current state of an environment (e.g., including the objects therein, etc.) informed by a record of prior states of the environment (e.g., including movement histories for the objects therein). Such information can be helpful as the autonomous platform plans its motion through the environment.

The autonomy system 200 can include the planning system 250, which can be configured to determine how the autonomous platform is to interact with and move within its environment. The planning system 250 can determine one or more motion plans for an autonomous platform. A motion plan can include one or more trajectories (e.g., motion trajectories) that indicate a path for an autonomous platform to follow. A trajectory can be of a certain length or time range. The length or time range can be defined by the computational planning horizon of the planning system 250. A motion trajectory can be defined by one or more waypoints (with associated coordinates). The waypoint(s) can be future location(s) for the autonomous platform. The motion plans can be continuously generated, updated, and considered by the planning system 250.

The motion planning system 250 can determine a strategy for the autonomous platform. A strategy may be a set of discrete decisions (e.g., yield to actor, reverse yield to actor, merge, lane change) that the autonomous platform makes. The strategy may be selected from a plurality of potential strategies. The selected strategy may be a lowest cost strategy as determined by one or more cost functions. The cost functions may, for example, evaluate the probability of a collision with another actor or object.

The planning system 250 can determine a desired trajectory for executing a strategy. For instance, the planning system 250 can obtain one or more trajectories for executing one or more strategies. The planning system 250 can evaluate trajectories or strategies (e.g., with scores, costs, rewards, constraints, etc.) and rank them. For instance, the planning system 250 can use forecasting output(s) that indicate interactions (e.g., proximity, intersections, etc.) between trajectories for the autonomous platform and one or more objects to inform the evaluation of candidate trajectories or strategies for the autonomous platform. In some implementations, the planning system 250 can utilize static cost(s) to evaluate trajectories for the autonomous platform (e.g., “avoid lane boundaries,” “minimize jerk,” etc.). Additionally or alternatively, the planning system 250 can utilize dynamic cost(s) to evaluate the trajectories or strategies for the autonomous platform based on forecasted outcomes for the current operational scenario (e.g., forecasted trajectories or strategies leading to interactions between actors, forecasted trajectories or strategies leading to interactions between actors and the autonomous platform, etc.). The planning system 250 can rank trajectories based on one or more static costs, one or more dynamic costs, or a combination thereof. The planning system 250 can select a motion plan (and a corresponding trajectory) based on a ranking of a plurality of candidate trajectories. In some implementations, the planning system 250 can select a highest ranked candidate, or a highest ranked feasible candidate.

The planning system 250 can then validate the selected trajectory against one or more constraints before the trajectory is executed by the autonomous platform.

To help with its motion planning decisions, the planning system 250 can be configured to perform a forecasting function. The planning system 250 can forecast future state(s) of the environment. This can include forecasting the future state(s) of other actors in the environment. In some implementations, the planning system 250 can forecast future state(s) based on current or past state(s) (e.g., as developed or maintained by the perception system 240). In some implementations, future state(s) can be or include forecasted trajectories (e.g., positions over time) of the objects in the environment, such as other actors. In some implementations, one or more of the future state(s) can include one or more probabilities associated therewith (e.g., marginal probabilities, conditional probabilities). For example, the one or more probabilities can include one or more probabilities conditioned on the strategy or trajectory options available to the autonomous platform. Additionally or alternatively, the probabilities can include probabilities conditioned on trajectory options available to one or more other actors.

In some implementations, the planning system 250 can perform interactive forecasting. The planning system 250 can determine a motion plan for an autonomous platform with an understanding of how forecasted future states of the environment can be affected by execution of one or more candidate motion plans. By way of example, with reference again to FIG. 1, the autonomous platform 110 can determine candidate motion plans corresponding to a set of platform trajectories 112A-C that respectively correspond to the first actor trajectories 122A-C for the first actor 120, trajectories 132 for the second actor 130, and trajectories 142 for the third actor 140 (e.g., with respective trajectory correspondence indicated with matching line styles). For instance, the autonomous platform 110 (e.g., using its autonomy system 200) can forecast that a platform trajectory 112A to more quickly move the autonomous platform 110 into the area in front of the first actor 120 is likely associated with the first actor 120 decreasing forward speed and yielding more quickly to the autonomous platform 110 in accordance with first actor trajectory 122A. Additionally or alternatively, the autonomous platform 110 can forecast that a platform trajectory 112B to gently move the autonomous platform 110 into the area in front of the first actor 120 is likely associated with the first actor 120 slightly decreasing speed and yielding slowly to the autonomous platform 110 in accordance with first actor trajectory 122B. Additionally or alternatively, the autonomous platform 110 can forecast that a platform trajectory 112C to remain in a parallel alignment with the first actor 120 is likely associated with the first actor 120 not yielding any distance to the autonomous platform 110 in accordance with first actor trajectory 122C. Based on comparison of the forecasted scenarios to a set of desired outcomes (e.g., by scoring scenarios based on a cost or reward), the planning system 250 can select a motion plan (and its associated trajectory) in view of the autonomous platform's interaction with the environment 100. In this manner, for example, the autonomous platform 110 can interleave its forecasting and motion planning functionality.

To implement selected motion plan(s), the autonomy system 200 can include a control system 260 (e.g., a vehicle control system). Generally, the control system 260 can provide an interface between the autonomy system 200 and the platform control devices 212 for implementing the strategies and motion plan(s) generated by the planning system 250. For instance, the control system 260 can implement the selected motion plan/trajectory to control the autonomous platform's motion through its environment by following the selected trajectory (e.g., the waypoints included therein). The control system 260 can, for example, translate a motion plan into instructions for the appropriate platform control devices 212 (e.g., acceleration control, brake control, steering control, etc.). By way of example, the control system 260 can translate a selected motion plan into instructions to adjust a steering component (e.g., a steering angle) by a certain number of degrees, apply a certain magnitude of braking force, increase/decrease speed, etc. In some implementations, the control system 260 can communicate with the platform control devices 212 through communication channels including, for example, one or more data buses (e.g., controller area network (CAN), etc.), onboard diagnostics connectors (e.g., OBD-II, etc.), or a combination of wired or wireless communication links. The platform control devices 212 can send or obtain data, messages, signals, etc. to or from the autonomy system 200 (or vice versa) through the communication channel(s).

The autonomy system 200 can receive, through communication interface(s) 206, assistive signal(s) from remote assistance system 270. Remote assistance system 270 can communicate with the autonomy system 200 over a network (e.g., as a remote system 160 over network 170). In some implementations, the autonomy system 200 can initiate a communication session with the remote assistance system 270. For example, the autonomy system 200 can initiate a session based on or in response to a trigger. In some implementations, the trigger may be an alert, an error signal, a map feature, a request, a location, a traffic condition, a road condition, etc.

After initiating the session, the autonomy system 200 can provide context data to the remote assistance system 270. The context data may include sensor data 204 and state data of the autonomous platform. For example, the context data may include a live camera feed from a camera of the autonomous platform and the autonomous platform's current speed. An operator (e.g., human operator) of the remote assistance system 270 can use the context data to select assistive signals. The assistive signal(s) can provide values or adjustments for various operational parameters or characteristics for the autonomy system 200. For instance, the assistive signal(s) can include way points (e.g., a path around an obstacle, lane change, etc.), velocity or acceleration profiles (e.g., speed limits, etc.), relative motion instructions (e.g., convoy formation, etc.), operational characteristics (e.g., use of auxiliary systems, reduced energy processing modes, etc.), or other signals to assist the autonomy system 200.

The autonomy system 200 can use the assistive signal(s) for input into one or more autonomy subsystems for performing autonomy functions. For instance, the planning subsystem 250 can receive the assistive signal(s) as an input for generating a motion plan. For example, assistive signal(s) can include constraints for generating a motion plan. Additionally or alternatively, assistive signal(s) can include cost or reward adjustments for influencing motion planning by the planning subsystem 250. Additionally or alternatively, assistive signal(s) can be considered by the autonomy system 200 as suggestive inputs for consideration in addition to other received data (e.g., sensor inputs, etc.).

The autonomy system 200 may be platform agnostic, and the control system 260 can provide control instructions to platform control devices 212 for a variety of different platforms for autonomous movement (e.g., a plurality of different autonomous platforms fitted with autonomous control systems). This can include a variety of different types of autonomous vehicles (e.g., sedans, vans, SUVs, trucks, electric vehicles, combustion power vehicles, etc.) from a variety of different manufacturers/developers that operate in various different environments and, in some implementations, perform one or more vehicle services.

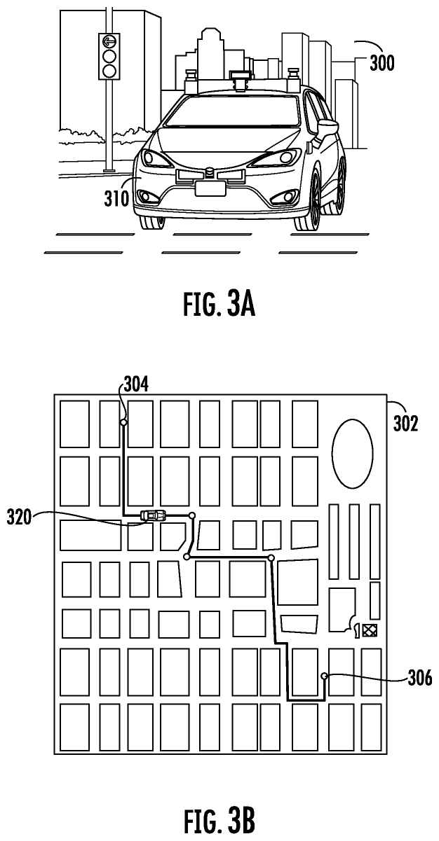

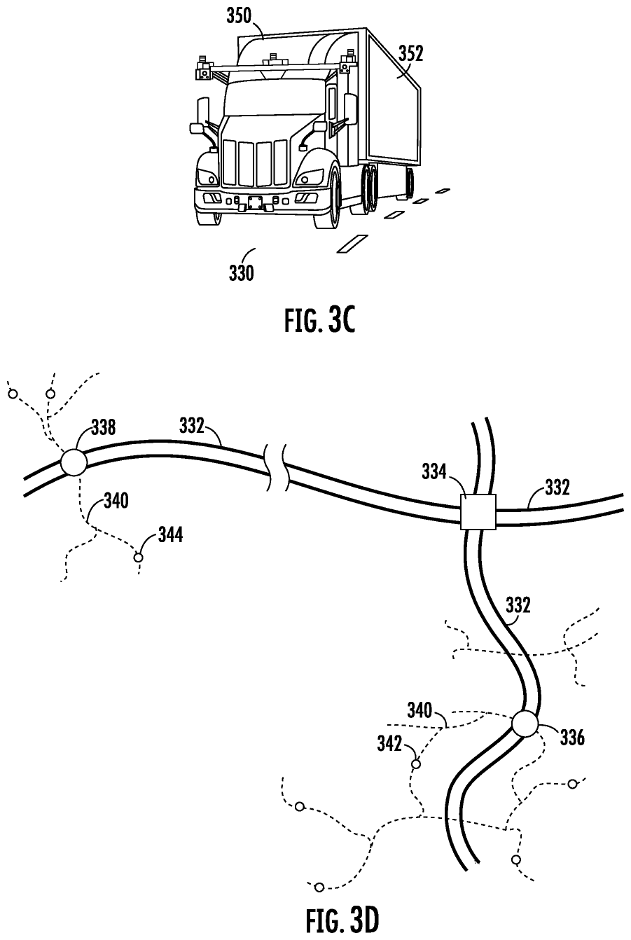

For example, with reference to FIG. 3A, an operational environment can include a dense environment 300. An autonomous platform can include an autonomous vehicle 310 controlled by the autonomy system 200. In some implementations, the autonomous vehicle 310 can be configured for maneuverability in a dense environment, such as with a configured wheelbase or other specifications. In some implementations, the autonomous vehicle 310 can be configured for transporting cargo or passengers. In some implementations, the autonomous vehicle 310 can be configured to transport numerous passengers (e.g., a passenger van, a shuttle, a bus, etc.). In some implementations, the autonomous vehicle 310 can be configured to transport cargo, such as large quantities of cargo (e.g., a truck, a box van, a step van, etc.) or smaller cargo (e.g., food, personal packages, etc.).

With reference to FIG. 3B, a selected overhead view 302 of the dense environment 300 is shown overlaid with an example trip/service between a first location 304 and a second location 306. The example trip/service can be assigned, for example, to an autonomous vehicle 320 by a remote computing system. The autonomous vehicle 320 can be, for example, the same type of vehicle as autonomous vehicle 310. The example trip/service can include transporting passengers or cargo between the first location 304 and the second location 306. In some implementations, the example trip/service can include travel to or through one or more intermediate locations, such as to onload or offload passengers or cargo. In some implementations, the example trip/service can be prescheduled (e.g., for regular traversal, such as on a transportation schedule). In some implementations, the example trip/service can be on-demand (e.g., as requested by or for performing a taxi, rideshare, ride hailing, courier, delivery service, etc.).

With reference to FIG. 3C, in another example, an operational environment can include an open travel way environment 330. An autonomous platform can include an autonomous vehicle 350 controlled by the autonomy system 200. This can include an autonomous tractor for an autonomous truck. In some implementations, the autonomous vehicle 350 can be configured for high payload transport (e.g., transporting freight or other cargo or passengers in quantity), such as for long distance, high payload transport. For instance, the autonomous vehicle 350 can include one or more cargo platform attachments such as a trailer 352. Although depicted as a towed attachment in FIG. 3C, in some implementations one or more cargo platforms can be integrated into (e.g., attached to the chassis of, etc.) the autonomous vehicle 350 (e.g., as in a box van, step van, etc.).

With reference to FIG. 3D, a selected overhead view of open travel way environment 330 is shown, including travel ways 332, an interchange 334, transfer hubs 336 and 338, access travel ways 340, and locations 342 and 344. In some implementations, an autonomous vehicle (e.g., the autonomous vehicle 310 or the autonomous vehicle 350) can be assigned an example trip/service to traverse the one or more travel ways 332 (optionally connected by the interchange 334) to transport cargo between the transfer hub 336 and the transfer hub 338. For instance, in some implementations, the example trip/service includes a cargo delivery/transport service, such as a freight delivery/transport service. The example trip/service can be assigned by a remote computing system. In some implementations, the transfer hub 336 can be an origin point for cargo (e.g., a depot, a warehouse, a facility, etc.) and the transfer hub 338 can be a destination point for cargo (e.g., a retailer, etc.). However, in some implementations, the transfer hub 336 can be an intermediate point along a cargo item's ultimate journey between its respective origin and its respective destination. For instance, a cargo item's origin can be situated along the access travel ways 340 at the location 342. The cargo item can accordingly be transported to the transfer hub 336 (e.g., by a human-driven vehicle, by the autonomous vehicle 310, etc.) for staging. At the transfer hub 336, various cargo items can be grouped or staged for longer distance transport over the travel ways 332.

In some implementations of an example trip/service, a group of staged cargo items can be loaded onto an autonomous vehicle (e.g., the autonomous vehicle 350) for transport to one or more other transfer hubs, such as the transfer hub 338. For instance, although not depicted, it is to be understood that the open travel way environment 330 can include more transfer hubs than the transfer hubs 336 and 338, and can include more travel ways 332 interconnected by more interchanges 334. A simplified map is presented here for purposes of clarity only. In some implementations, one or more cargo items transported to the transfer hub 338 can be distributed to one or more local destinations (e.g., by a human-driven vehicle, by the autonomous vehicle 310, etc.), such as along the access travel ways 340 to the location 344. In some implementations, the example trip/service can be prescheduled (e.g., for regular traversal, such as on a transportation schedule). In some implementations, the example trip/service can be on-demand (e.g., as requested by or for performing a chartered passenger transport or freight delivery service).

To improve the performance of an autonomous platform, such as an autonomous vehicle controlled at least in part using autonomy system(s) 200 (e.g., the autonomous vehicles 310 or 350), the perception system 240 can detect emergency vehicles according to example aspects of the present disclosure.

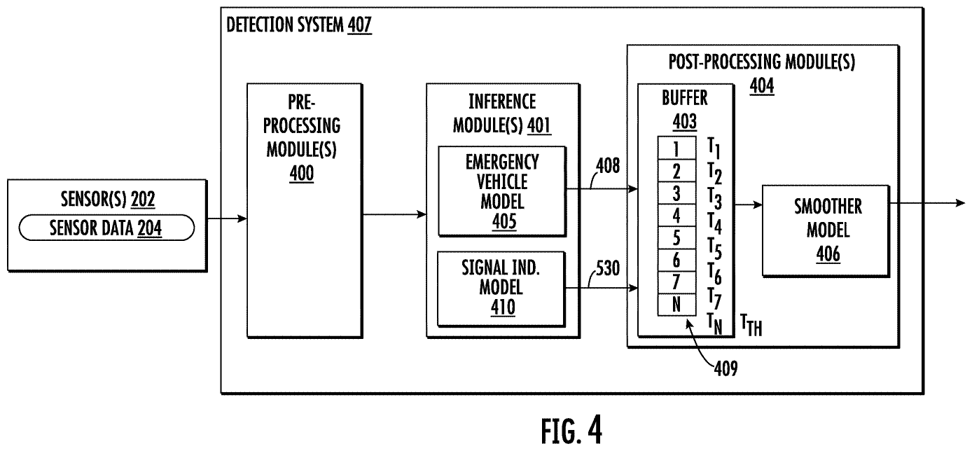

FIG. 4 is a block diagram of a detection system 407, according to some implementations of the present disclosure. The detection system 407 can be included, for example, an emergency vehicle detection system and/or vehicle light detection system within the perception system 240 of an autonomous vehicle. Although FIG. 4 illustrates an example implementation of a detection system 407 having various components, it is to be understood that the components can be rearranged, combined, omitted, etc. within the scope of and consistent with the present disclosure.

The detection system 407 can include a pre-processing module 400, an inference module 401, a buffer 403, and a post-processing module 404. In some examples, the inference module 401 can include a machine-learned emergency vehicle model 405. In some examples, the post-processing module 404 can include a smother model 406.

To help detect an emergency vehicle or an active vehicle signal indicator, the detection system 407 can obtain sensor data 204. As described herein, the sensor data 204 can include data captured through one or more sensors 202 onboard an autonomous vehicle. This can include radar data, LIDAR data, image data, etc. For example, the sensor data 204 can include image frames captured during instances of real-world driving, and associated times in which the objects in the environment were perceived. The sensor data 204 can include data collected from other sources (e.g. roadside cameras, aerial vehicles, etc.).

The senor data 204 can be associated with a plurality of times. For instance, the sensor data 204 can include a plurality of image frames indicative of an actor in an environment of the autonomous vehicle. Each respective image frame can be associated with a time/time stamp at which the image frame was captured. For instance, the plurality of image frames can include a sequence of image frames taken across a plurality of times and depicting an actor in the environment. The actor can include, for example, another vehicle. The environment can be, for example, the environment outside of and surrounding the autonomous vehicle (e.g., within a sensor field of view). In some implementations, the sensor data 204 can include video data. Additionally, or alternatively, the sensor data 204 can include multiple single, static images.

The detection system 407 can pre-process sensor data 204. The pre-processing can be performed by the pre-processing module 400.

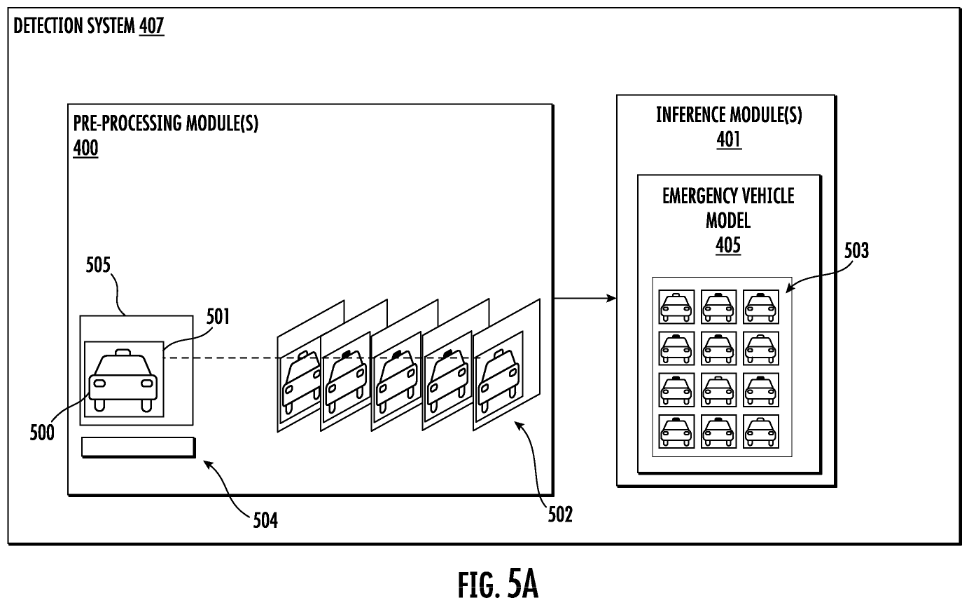

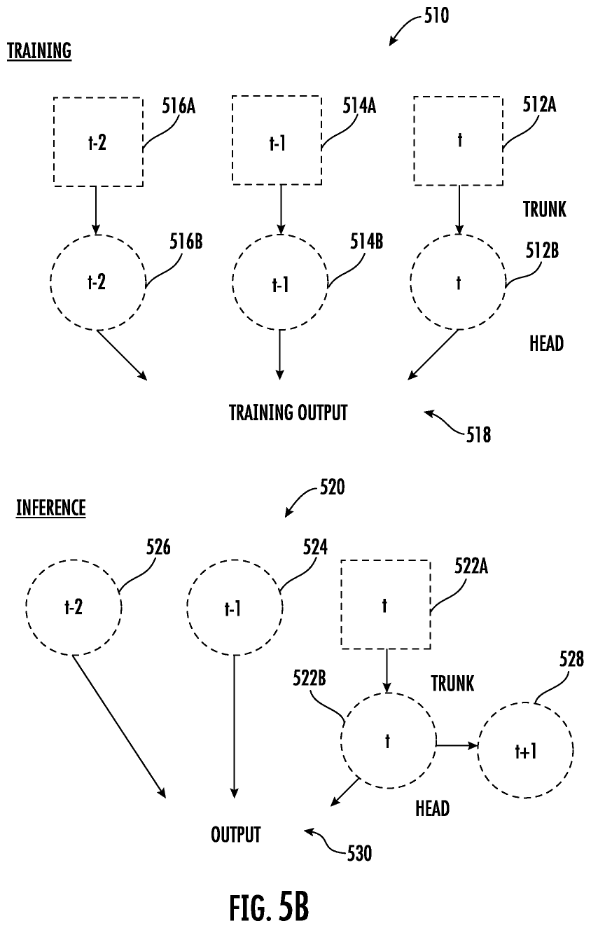

FIG. 5 is a block diagram of an example data flow for pre-processing sensor data according to some implementations of the present disclosure. In FIG. 5, at a time after the sensor data 204 has been captured by the sensors 202, the sensor data 204 can be processed by a pre-processing module 400.

For instance, the pre-processing module 400 can obtain image frames 505 depicting portions of an environment of an autonomous vehicle and an actor 500. The pre-processing module 400 can obtain track data 504 for the actor within the environment of the autonomous vehicle. The track data 504 can be generated by another system of the autonomous vehicle. The track data 504 can include tracks for the actors depicted in the respective image frames 505. The tracks can include state date and a bounding shape 501 of the actor. State data can include the position, velocity, acceleration, etc. of an actor at the time at which the actor was perceived.

The bounding shape 501 can be a shape (e.g., a polygon) that includes the actor 500 depicted in a respective image frame. For example, as shown in FIG. 5, the bounding shape 501 can include a square that encapsulates the actor 500 (e.g., a bounding box). One of ordinary skill in the art will understand that other shapes can be used such as circles, etc. In some implementations, the bounding shape 501 can include a shape that matches the outermost boundaries/perimeter of the actor 500 and the contours of those boundaries. The bounding shape can be generated on a per pixel level. The track data 504 can include the x, y, z coordinates of the bounding shape center and the length width and height of the bounding shape. In some examples, the track's state can fit a multivariate normal distribution.

To help determine a relevant dataset, the pre-processing module 400 can analyze actors based on the centroids of their associated bounding shapes. For example, the pre-processing module 400 can determine that a centroid of the bounding shape 501 is within a projected field of view of the autonomous vehicle. In response to determining the centroid of the bounding shape 500 is within the projected field of view, the pre-processing module 400 can generate input data 502 for the machine-learned emergency vehicle model 405 based on the sensor data 204.

In some examples, the pre-processing module 400 identifies respective coordinates of the corners of each track's bounding shape 501. The pre-processing model 400 can project the three-dimensional coordinates of the corners of each track's bounding shape 501 into a forward camera image. For each actor whose projected centroid is within the image, pre-processing module 400 can use the smallest shape (e.g., square, etc.) that encapsulates the projected corners to crop the image and resize it to a pre-determined length and width (e.g., to 224×224 in length and width).

In some examples, actors whose centroid is out of the field of view of the sensor 202 can be ignored. In other examples, actors whose projected width is smaller than a threshold amount (e.g., L=18.6 pixels) can be ignored. By ignoring actors/tracks whose centroid is out of the field of view of the sensor 200 or whose projected width is smaller than a threshold, actors that are too far away from the autonomous vehicle will not be assessed. This can help focus the vehicle's onboard computational resources (e.g., power, processing, memory, bandwidth), and avoid unnecessary usage on actors that may not be identified in a given frame with a sufficient confidence level.

The pre-processing module 400 can generate valid image patches from cropped image frames 502. The image patches that have not been ignored can be considered valid. The image patches can be batched into valid batched crops. In some examples the valid batched crops can be ranked from most importance to least importance. For instance, batching valid image crops and ranking batched crops, improves latency of the system by processing the most important batched crops first.

Pre-processing module 400 can provide valid batched crops to inference module 401 as input data 503 for the machine-learned emergency vehicle model 405. The inference module 401 can run the input data 503 through the emergency vehicle model 405 and output probabilities to decide whether an actor 500 in a respective image frame 505 is an active emergency vehicle or not.

The emergency vehicle model 405 can include one or more machine-learned models trained to determine whether an actor is an emergency vehicle and whether the emergency vehicle is in an active state. The emergency vehicle model 405 can be or can otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The emergency vehicle model 405 can be trained through the use of one or more model trainers and training data. The model trainers can be trained using one or more training or learning algorithms. One example training technique is backwards propagation of errors. In some examples, simulations can be implemented for obtaining the training data or for implementing the model trainer(s) for training or testing the model(s). In some examples, the model trainer(s) can perform supervised training techniques using labeled training data. As further described herein, the training data can include labelled image frames that have labels indicating whether or not an actor is an emergency vehicle, a type of an emergency vehicle, and bulb states of the lights of the emergency vehicle. In some examples, the training data can include simulated training data (e.g., training data obtained from simulated scenarios, inputs, configurations, environments, etc.).

Additionally, or alternatively, the model trainer(s) can perform unsupervised training techniques using unlabeled training data. By way of example, the model trainer(s) can train one or more components of a machine-learned model to perform emergency vehicle detection through unsupervised training techniques using an objective function (e.g., costs, rewards, heuristics, constraints, etc.). In some implementations, the model trainer(s) can perform a number of generalization techniques to improve the generalization capability of the model(s) being trained. Generalization techniques include weight decays, dropouts, or other techniques.

In some examples, the emergency vehicle model 405 can be a convolutional neural network. The convolutional neural network can include, for example, ResNet-18 as a backbone to extract image features, followed by an average pooling layer and a linear layer with a single output channel, and then a sigmoid function to output probabilities as to whether actors are emergency vehicles. Example model input dimensions can be expressed as [B, C, W, H], where B is the batch size, C is the RGB channels, and W & H represent the image size (width and height). In one example, the batch size (B) can be 32, the number of RBG channels (C) can be 3, and the image size (W=H) can be 224.

The ResNet backbone can use pretrained weights on an image dataset which is not frozen during training. The image dataset can be organized according to a hierarchy, in which each node of the hierarchy is depicted by hundreds/thousands of images and is grouped into sets of synsets, each expressing a distinct concept. Synsets can be interlinked by means of conceptual-semantic and lexical relations.

The emergency vehicle model 405 can use a focal loss, which can be good for imbalanced dataset. An Adam optimizer with 0 weight decay and an initial learning rate of 10-4 can be used. A model trainer can use a customized optimizer wrapper that will decrease the learning rate when there is no improvement in the loss for a certain number of iterations, and will stop training when the learning rate has dropped to a given low value.

The emergency vehicle model 405 can consolidate labels into binary targets. In example implementations, a positive target can be determined when the image frame contains an emergency vehicle and has an active (or bulb-on) state when the image is captured. In example implementations, a negative target can be determined when the image contains a non-emergency vehicle. In example implementations, a negative target can be determined when the image contains an emergency vehicle with an inactive (or bulb-off) state. The emergency vehicle model 405 can ignore emergency vehicles with inactive (or bulb-off) states. In this way, the emergency vehicle model 405 can effectively identify active emergency vehicles, which are of interest by the motion planning system 250.

For a respective image frame, the detection system 407 can determine, using the emergency vehicle model 405 that an actor (depicted the image frame) is an emergency vehicle. In some examples, the emergency vehicle model 405 can determine (and output) a category of the emergency vehicle from one of the following categories: a police car, ambulance, fire truck, tow truck, or another type of emergency vehicle. The emergency vehicle model 405 can determine that an actor is not an emergency vehicle. For instance, the emergency vehicle model 405 can determine a category of non-emergency vehicle for vehicles that are not emergency vehicles.

By way of example, the emergency vehicle model 405 can analyze the actor in the cropped image frame to determine a probability that the actor is an emergency vehicle. This can include analyzing the shape or position of the actor to determine whether the actor is a police car, an ambulance, a fire truck, a tow truck, or another type of emergency vehicle. In some examples, the emergency vehicle model 405 can analyze the shape or position of a light of the actor (e.g., a roof mounted light) to help determine whether the actor is an emergency vehicle. The presence of a longer roof mounted light on sedan can increase the probability that the actor is a police car.

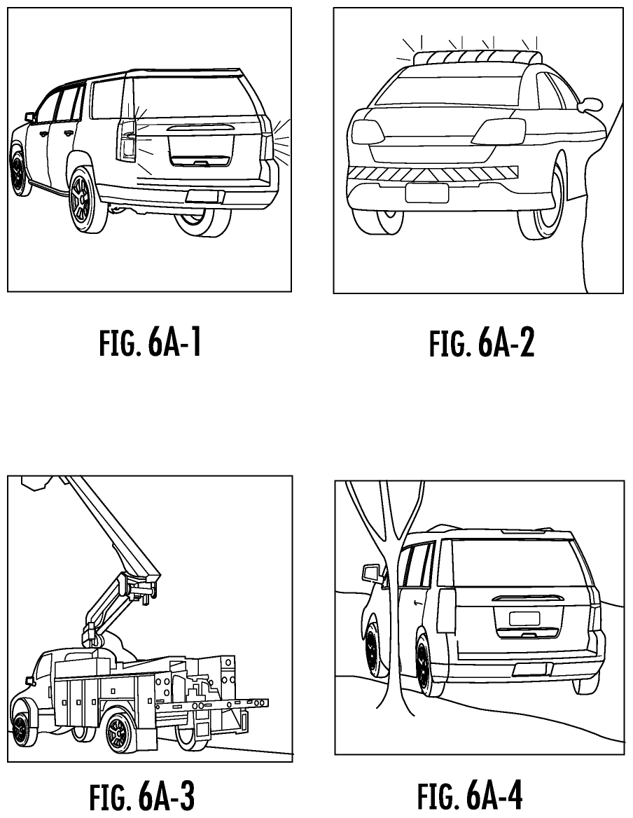

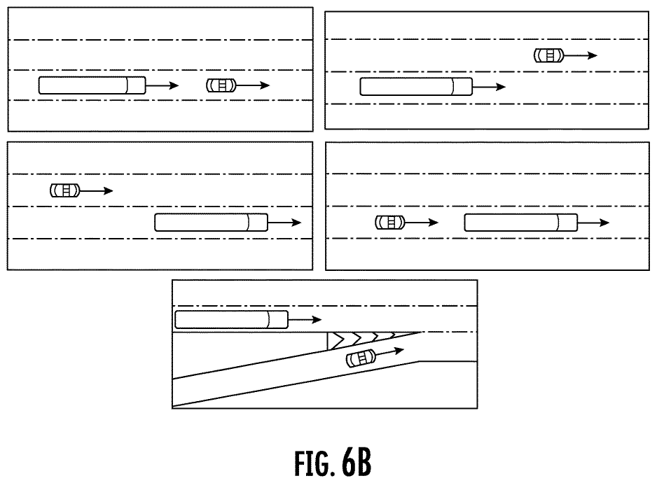

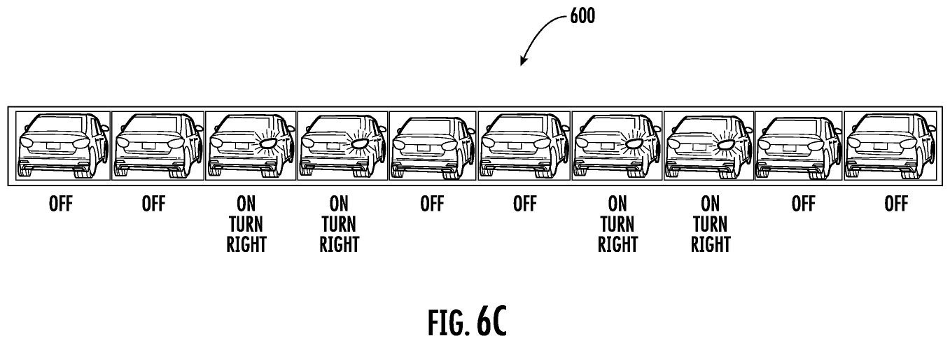

The probability can be reflective of the model's confidence level that the actor is an emergency vehicle. In some examples, a probability higher than a threshold probability (e.g., 50, 75, 90%, etc.) can result in a positive detection of an emergency vehicle. In some examples, a probability lower than the threshold probability can result in a determination that the actor is not an emergency vehicle in the respective image frame. An example of an actor that is not an emergency vehicle in a respective image frame is shown in FIG. 6A-4.

The emergency vehicle model 405 can predict whether or not an emergency vehicle is active or inactive based on the respective image frame. For instance, the emergency vehicle model 405 can determine a state of a light of the emergency vehicle in the respective image frame. The state can include a “on” state indicating a blub of the light is on/illuminated or an “off” state indicating a bulb of the light is off/unilluminated.

In some examples, the emergency vehicle model 405 can determine whether a bulb is on or off based on a characteristics (e.g., a color, intensity, brightness, etc.) of the pixels associated with the light. In some examples, the characteristics can be compared to those of other pixels in the respective image frame. The characteristics can include, for example, a color, a pattern, an intensity, a brightness, etc. Pattern, color, intensity, brightness, etc. can indicate that a bulb in the respective image frame is on or off.

The emergency vehicle model 405 can determine that an emergency vehicle is in the active state or the inactive state for the respective image frame based on the state of the light. The emergency vehicle 405 can determine that an emergency vehicle is active in the event that the light is in the on state. The emergency vehicle can determine that the emergency vehicle is inactive in the event that the light is in the off state. In some examples, color can be indicative of the type of emergency vehicle. For instance, a blue label can indicate that the emergency vehicle is an active police car. Example image frames with active emergency vehicles are shown in FIGS. 6A-1, 6A-2, and 6A-3.

As depicted in FIG. 4, the emergency vehicle model 405 can generate output data 408 indicating that an emergency vehicle is in an active state or an inactive state in the respective image frame. The output data 408 can include an image frame and a probability (as determined by the emergency vehicle model 405) that an emergency vehicle is in an active state or an inactive state in the respective image frame.

In some implementations, the output data 408 is stored in a buffer 403. The buffer 403 can include, for example, a cyclic buffer with a ledger of a number of valid outputs from the emergency vehicle model 405 (e.g., the last 25 valid outputs) for each vehicle track's history. In some examples, the buffer 403 can be included in the post-processing module 404. In some examples, the buffer 403 can be implemented as an intermediary between the inference module 401 and the post-processing module 404.

In some implementations, as further described herein, the buffer 403 is omitted as from the detection system 407.

The output data 408 can be stored as attribute data 409. The attribute data 409 can include the output data 408 and a time associated with the respective image frame. The time associated with the respective image frame can be the time at which the respective image frame was captured. In some examples, the attribute data 409 can include track data 504 associated with the emergency vehicle. This can include associating a track with a respective image frame for the detected emergency vehicle. In some examples, the output data 408/attribute data 409 can be indicative of a category of the emergency vehicle (e.g., police car, etc.).

The detection system 407 can determine that a threshold amount of attribute data exists for a plurality of image frames at a plurality of times. In an example, the detection system 407 can determine that the buffer 403 includes a threshold amount of attribute data 409 for a plurality of image frames at a plurality of times. The threshold amount of attribute data can include a threshold number of image frames (e.g., 6 frames) that have been processed by the emergency vehicle model 405.

The detection system 407 can use a second model to make a final determination that an emergency vehicle is an active emergency vehicle based on the attribute data 409. As depicted in FIG. 4, the post-processing module 404 can obtain the image frames from the buffer 403. The post-processing module 404 can include a smoother model 406. The smoother model 406 can include a down-stream smoother that handles bulb on-off cycles and infers the final overall state of the emergency vehicle.

For instance, the smoother model 406 can analyze a plurality of image frames (across a plurality of times) in the attribute data 409 and their active/inactive labels and make a final determination as to whether the depicted emergency vehicle is in an active state or an inactive state. The smoother model 406 can determine whether an emergency vehicle is an active emergency vehicle by calculating that greater than 50% of the plurality of image frames indicate that the emergency vehicle is in the active state.

In some examples, the smoother model 406 can determine at least one of the following: (1) a pattern of a light of the emergency vehicle; (2) a color of the light of the emergency vehicle; or (3) an intensity of the light of the emergency vehicle. Additionally, or alternatively, the smoother model can determine a type of emergency vehicle.

By way of example, the smoother model 406 can determine a color of an active bulb based on the plurality of image frames stored in the buffer 403. The smoother model 406 can determine that a flashing bulb is blue by calculating that greater than 50% of the image frames stored in the buffer 403 contain a color label of blue. In some implementations, the smoother model 406 can determine the category of the active emergency vehicle. For instance, the smoother model 406 can determine that an active emergency vehicle is a police car by calculating that greater than 50% of the image frames stored in the buffer 403 have been categorized with a police car label.

In some examples, the smoother model 406 can include a rules-based model including a heuristic set of rules. The set of rules can be developed to evaluate a plurality of image frames as described herein.

In some examples, the smoother model 406 can include one or more machine-learned models. This can include one or more machine-learned models trained to determine whether an actor is an active emergency vehicle given a plurality of image frames. The emergency vehicle model 405 can be or can otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. The one or more models can be trained through the use of one or more model trainers and training data. The model trainers can be trained using one or more training or learning algorithms to train the models to determine whether an emergency vehicle is active or inactive, type of emergency vehicle, characteristics, etc. based on a number of image frames.

An action for the autonomous vehicle can be performed based on the active emergency vehicle being within the environment of the autonomous vehicle. For example, data indicative of the emergency vehicle within the vehicle's environment can be provided to the planning system 250. The motion planning system 250 can forecast a motion of the active emergency vehicle, in the manner described herein for actors perceived by the autonomous vehicle.

The motion planning system 250 can generate a motion plan for the autonomous vehicle based on the active emergency vehicle. This can include, for example, generating a trajectory for the autonomous vehicle to decelerate to provide more distance between the autonomous vehicle and the active emergency vehicle, allow the active emergency vehicle to pass, allow the active emergency vehicle to merge onto a roadway, etc. In some examples, the trajectory can include the autonomous vehicle changing lanes or pulling over for the active emergency vehicle.

In some examples, the motion planning system 250 can take into account the active emergency vehicle in its trajectory generation and determine that the autonomous vehicle does not need to change acceleration, velocity, heading, etc. because the autonomous vehicle is already appropriately positioned with respect to the active emergency vehicle. This can include a scenario when the active emergency vehicle is already sufficiently positioned ahead of the autonomous vehicle.

The action for the autonomous vehicle can include controlling a motion of the autonomous vehicle based on the active emergency vehicle. The motion planning system 250 can provide data indicative of a trajectory that was generated based on the active emergency vehicle being within the environment. The control system 260 can control the autonomous vehicle's maneuvers based on the trajectory, as described herein. FIG. 6B illustrates example vehicle maneuvers with an active emergency vehicle within the environment of the autonomous vehicle.

Returning to FIG. 4, the detection system 407 can include a signal indicator model 410. The signal indicator model 410 can include one or more models configured to detect a signal of an object within the surrounding environment of the autonomous vehicle. This can include, for example, a signal light of a vehicle within the surrounding environment.

As described herein, the detection system 407 can obtain sensor data 204. The sensor data 204 can include a plurality of image frames indicative of an actor in an environment of an autonomous vehicle. The plurality of image frames can include a current image frame (e.g., at current timestep t) and one or more historical image frames. The historical image frames can be associated with one or more previous time steps (e.g., t−1, t−2, etc.) from the current time step t of the current image frame.

The signal indicator model 410 can include one or more models trained to determine characteristics about a signal indicator of an actor within the current image frame, as informed by the historical image frames. For example, the signal indicator model 410 can be a convolutional neural network trained using one or more training techniques.

The signal indicator model 410 can be trained through the use of one or more model trainers and training data. The model trainers can be trained using one or more training or learning algorithms. One example training technique is backwards propagation of errors. In some examples, simulations can be implemented for obtaining the training data or for implementing the model trainer(s) for training or testing the model(s). In some examples, the model trainer(s) can perform supervised training techniques using labeled training data. The training data can include label ed image frames that have labels indicating characteristics of signal indicators. The characteristics can include: a signal indicator of an object, a type of signal indicator (e.g., turn signal light, brake signal light, hazard signal light), a position of the indicator on/relative to the actor (e.g., left, right, front, back), bulb states of the signal indicator (e.g., whether the light is on or off), color, or other characteristics. In some examples, the training data can include simulated training data (e.g., training data obtained from simulated scenarios, inputs, configurations, environments, etc.). FIG. 6C depicts example training data 600 including a plurality of image frames with label ed characteristics of the signal indicators depicted in the image frames. The image frames can also include metadata indicating their respective time steps (e.g., t, t−1, t−2, etc.).

Additionally, or alternatively, the model trainer(s) can perform unsupervised training techniques using unlabeled training data. By way of example, the model trainer(s) can train one or more components of a machine-learned model to perform signal indicator detection through unsupervised training techniques using an objective function (e.g., costs, rewards, heuristics, constraints, etc.). In some implementations, the model trainer(s) can perform a number of generalization techniques to improve the generalization capability of the model(s) being trained. Generalization techniques include weight decays, dropouts, or other techniques.

FIG. 5B depicts a training architecture 510 for the signal indicator model 410. In performing a training instance, the training data can include a first image crop 512A taken at time t. The first image crop 512A can be considered the current image frame associated with a current timestep t. The training data can also include historical image frames. For example, the training data can include a second image crop 514A taken at time t−1 and a third image crop 516A taken at time t−2.

The image crops 512A, 514A, 516A can be processed to generate an intermediate output such as embeddings 512B, 514B, 516B. To do so, the training architecture 510 can include a model trunk. The trunk can include a common network for various tasks such as, for example, processing the various image frames. For instance, the first image crop 512A can be processed using the trunk to generate a first embedding 512B associated with timestep t. The second image crop 514A can be processed using the trunk to generate a second embedding 514B associated with timestep t−1. The third image crop 516A can be processed using the trunk to generate a third embedding 516B associated with timestep t−2. Each embedding can capture, for example, the state of a signal light (e.g., turn signal) of a vehicle that appears in the image crops 512A, 514A, 516A at their respective timesteps. The state can indicate whether the light is in an active state (e.g., on) or an inactive state (e.g., off).

The embeddings 512A, 512B, 512C can be processed by the model head to generate a training output 518. The training output 518 can indicate the state of a signal indicator for the first image crop 512A (e.g., the current image frame), which is informed by the state of the signal indicator in the second and third image crops 514A, 516A (e.g., the historical image frames). For example, the signal indicator model 410 can determine whether a turn signal shown in the image crops 512A, 514A, 516A is active in the current timestep t based on the previous timesteps t−1 and t−2. The embeddings 512A, 512B, 512C may indicate that the light of the turn signal may be illuminated/on at timestep t−2, off/not illuminated at timestep t−1, and illuminated/on at timestep t. This may be indicative of a flashing pattern and, thus, indicate that the turn signal is in an active state at the current timestep t.

The training output 518 can indicate the prediction of the signal indicator model 410 during the training instance. The training output 518 can be compared to training data to determine the progress of the training and the precision of the model. This can include comparing the prediction of the signal indicator model 410 in the training output 518 (e.g., indicating the turn signal is active in the current timestep) to a ground truth. Based on the comparison, one or more loss metrics or objectives can be generated and, if needed, at least one parameter of at least a portion of the signal indicator model 410 can be modified based on the loss metrics or at least one of the objectives.

The signal indicator model 410 can be trained to determine other characteristics of a signal indicator. For example, the signal indicator model 410 can be trained to determine a type of signal indicator (e.g., turn signal light, brake signal light, hazard signal light, other light), a position of the signal indicator relative to the actor (e.g., left turn signal, right turn signal, etc.), a color, or other characteristics. The training data can include labels indicative of these characteristics and the training output 518 of the signal indicator model 410 can indicate the model's prediction of the type of signal indicator, position of the signal indicator, color, etc. As similarly described above, these prediction can be compared to a ground truth to assess the model's progress and modify model parameters, if needed.

The inference architecture 520 of the signal indicator model 410 can diverge from the training architecture 510. More particularly, when evaluating a current image frame, the signal indicator model 410 may have already processed historical image frames. In an example, the signal indicator model 410 may have already generated a first previous embedding 524 based on an image frame at timestep t−1 and a second previous embedding 526 based on an image frame at timestep t−2. These previous embeddings can be stored in a memory (e.g., a local cache) so that they can be accessed and used to inform the analysis for an image crop 522A that is based on a current image frame (e.g., of an RBG image) at current timestep t.

In the event that the signal indicator model 410 has not yet processed historical image frames relative to a current image frame, the signal indicator model 410 may perform its analysis based on a single, current image frame, without it being informed by historical time frames.

The image crop 522A can be generated using the pre-processing module(s) 400 as described herein and provided as input data to the signal indicator model 410.

The signal indicator model 410 can determine a signal indicator of an actor within the image crop 522A. For a current image frame, the detection system 407 can determine, using the signal indicator model 410, that a portion of an actor (depicted the current image frame) is a signal indicator. In some examples, the signal indicator model 405 can determine (and output) a type of the signal indicator from one of the following types: a turn signal indicator, a hazard signal indicator, a braking signal indicator, or another type of signal indicator.

By way of example, the signal indicator model 410 can analyze the actor in the image crop 522A to determine a probability that a portion of the depicted actor is a signal indicator. This can include analyzing the shape or position of a subset of pixels representing the actor to determine whether the subset is a turn signal light, brake light, etc. In some examples, the signal indicator model 410 can analyze the shape or position of the subset of pixels of the actor to help identify the type of signal indicator (e.g., a left turn signal light).

The probability can be reflective of the model's confidence level that the actor contains a signal indicator. In some examples, a probability higher than a threshold probability (e.g., 95%, etc.) can result in a positive detection. A probability lower than the threshold probability can result in a determination that a signal indicator is not captured in the image crop 522A.

The detector system 407 can generate, using the signal indicator model 410 and based on the one or more historical image frames, output data 530. By way of example, the vehicle indicator model 410 can predict whether or not a right turn signal of an actor is active or inactive based on the current image frame as informed by the previous embeddings 524, 526. The signal indictor model 410 can pass the image crop 522A through the trunk to generate a current embedding 522B associated with the current timestep t. The current embedding 522B can be saved for analysis of the next time frame associated with timestep t+1. The signal indicator model 410 can then pass the current embedding 522B to through the model head and concatenate the current embedding 522B (e.g., for timestep t) with the previous embeddings 524, 526 (e.g., for timesteps t−1 and t−2) to generate output data 530.

The output data 530 can indicate one or more characteristics of the signal indicator, as determined by the signal indicator model 410. The characteristic(s) can indicate the type of signal indicator or position of the signal indicator. The characteristic(s) can indicate the signal indicator is in an active state or an inactive state in the current image frame. For example, as described herein, the signal indicator model 410 can determine that there is a back, right turn signal of the actor depicted in the current image crop 522A. The current image crop 522A (and the current embedding 522B) at timestep t, as well as the first previous embedding 524 at t−1, can indicate the right turn light as illuminated/on. The second previous embedding 526 at t−2 can indicate the right turn light as not illuminated/off. Based on the concatenation of the current embedding 522A and the previous embeddings 524, 526, the signal indicator model 410 can determine that at timestep t, for the current image frame, the right turn light is in an active state. Accordingly, the output data 530 can indicate that the signal indicator depicted in the current image frame is a back, right turn signal that is active at timestep t. In some implementations, the output data 530 indicates the color of the turn signal, for example, as red.

Returning to FIG. 4, the detector system 407 can determine that the signal indicator of the actor is active or inactive based on at least the current image frame. For instance, the output data 530 can be provided to the post-processing modules(s) 404. The output data 530 can include the current image frame, the timestep associated with the current time step t, and characteristics associated with the signal indicator that were determined by the signal indicator model 410. In an example, the output data 530 can include a probability (as determined by the signal indicator model 410) that a signal indicator is in an active state or an inactive state in the respective image frame.

In some implementations, the output data 530 is stored in the buffer 403. The output data 530 can be stored as attribute data 409. The attribute data 409 can include the output data 530 and a time associated with the respective image frame.

The detection system 407 can determine that a threshold amount of attribute data exists for a plurality of image frames at a plurality of times. In an example, the detection system 407 can determine that the buffer 403 includes a threshold amount of attribute data 409 for a plurality of image frames at a plurality of times. The threshold amount of attribute data can include a threshold number of image frames (e.g., 6 frames) that have been processed by the signal indicator model 410. The smoother model 409 can be utilized to analyze the attribute data 409 to generate an output of the detector system 407, as previously described herein.

In some implementations, the post-processing module(s) 404 are not utilized for the output data 530. This may occur in the event the confidence associated with the output data 513 is sufficient because it is already temporarily reasoned by the signal indicator model 410 analyzing the current image frame based on historical image frames.

An action for the autonomous vehicle can be performed based on the actor's signal indicator being active or inactive. For example, data indicative of the signal indicator, it's type, state, position, etc. can be provided to the planning system 250. The motion planning system 250 can forecast a motion of the actor based on the signal indicator, in the manner described herein for actors perceived by the autonomous vehicle. The state of the signal indicator can help determine the intention of the actor. This can be particularly advantageous for actors that may not show dynamic motion parameters (e.g., heading/velocity changes) that indicate the actor's intention (e.g., to turn left).

The motion planning system 250 can generate a motion plan for the autonomous vehicle based on the state of the signal indicator. This can include, for example, generating a trajectory for the autonomous vehicle to decelerate to allow a vehicle with an active left turn signal to take a left turn in front of the autonomous vehicle, nudge over within a lane to provide more distance between the autonomous vehicle and an actor on a shoulder with flashing hazard lights, decelerate to allow an actor with an active right turn signal to merge into the same lane as the autonomous vehicle, decelerate in response to an actor with active brake lights, etc. In some examples, the trajectory can include the autonomous vehicle changing lanes in response to the signal indicator of the actor.

In some examples, the motion planning system 250 can take into account the state of the signal indicator into its trajectory generation and determine that the autonomous vehicle does not need to change acceleration, velocity, heading, etc. because the autonomous vehicle is already appropriately positioned with respect to the actor. This can include a scenario when the actor is positioned behind the autonomous vehicle.

The action for the autonomous vehicle can include controlling a motion of the autonomous vehicle based on the actor's signal indicator. The motion planning system 250 can provide data indicative of a trajectory that was generated based on the actor's signal indicator. The control system 260 can control the autonomous vehicle's maneuvers based on the trajectory, as described herein.

The signal indicator model 410 can be run in parallel, concurrently with the emergency vehicle model 405. For example, the signal indicator model 410 and the emergency vehicle model 405 can evaluate the same image frame (e.g., an image crop thereof). The outputs from the models can be combined, stored in association with one another, or otherwise processed in a manner that provides more robust information about an actor. For instance, the emergency vehicle model 405 can determine that an actor is an emergency vehicle, while the signal indicator model 410 can determine that the actor has an active left turn signal. The combination of the outputs can therefore inform the autonomous vehicle that there is an active emergency vehicle that is intending to turn left.

In some implementations, the signal indicator model 410 and the emergency vehicle model 405 can run in series, with an output from one model being utilized as an input for another.

In some implementations, the functionality of the signal indicator model 410 and the emergency vehicle model 405 can be performed by one model. This can allow the respective image frames processed by the emergency vehicle model 405 to be informed by historical image frames associated with previous timesteps. For example, for a respective time frame associated with time step t, a machine-learned model can be configured to process one or more historical image frames to generate the output data 408. The one or more historical image frames can be associated with one or more timesteps t−1, t−2 that are previous to a timestep associated with the respective time frame.

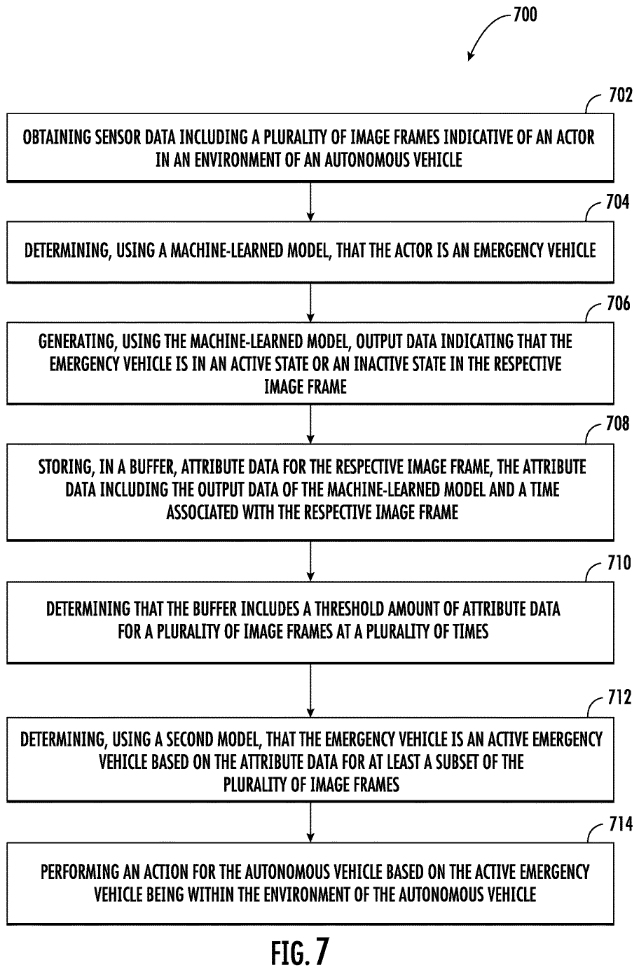

FIG. 7 depicts a flowchart of a method 700 for detecting an active emergency vehicle and controlling an autonomous vehicle according to aspects of the present disclosure. One or more portion(s) of the method 700 can be implemented by a computing system that includes one or more computing devices such as, for example, the computing systems described with reference to the other figures (e.g., autonomous platform 110, vehicle computing system 180, remote system(s) 160, a system of FIGS. 4, 5, 10, etc.). Each respective portion of the method 700 can be performed by any (or any combination) of one or more computing devices. Moreover, one or more portion(s) of the method 700 can be implemented on the hardware components of the device(s) described herein (e.g., as in FIGS. 1-5, 10 etc.), for example, to detect an active emergency vehicle and control an autonomous vehicle with respect to the same.

FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of method 700 can be performed additionally, or alternatively, by other systems.

At 702, the method 700 includes obtaining sensor data including a plurality of image frames indicative of an actor in an environment of an autonomous vehicle. For instance, a computing system (e.g., onboard the autonomous vehicle) can obtain image data from one or more cameras onboard the autonomous vehicle. The image data can include a plurality of image frames at a plurality of times. This can include a first image frame captured at a first time.

At 704, the method 700 includes, for a respective image frame, determining, using a machine-learned model, that an actor is an emergency vehicle. For instance, the computing system can access a machine-learned emergency vehicle model from an accessible memory (e.g., onboard the autonomous vehicle). As described herein, the emergency vehicle model can be trained based on labeled training data. The labeled training data can be based on point cloud data and image data. Moreover, the labeled training data can be indicative of a plurality of training actors (e.g., vehicles), at least one respective training actor being labelled with an emergency vehicle label. In some example, the emergency vehicle label can indicate a type of emergency vehicle of the respective training actor or that the training actor is not an emergency vehicle. In some examples, a respective training actor includes an activity label indicating that the respective training actor is in an active state or an inactive state based on a light of the training actor.

As described herein, the emergency vehicle model can process a first image frame to predict whether it includes an active emergency vehicle.

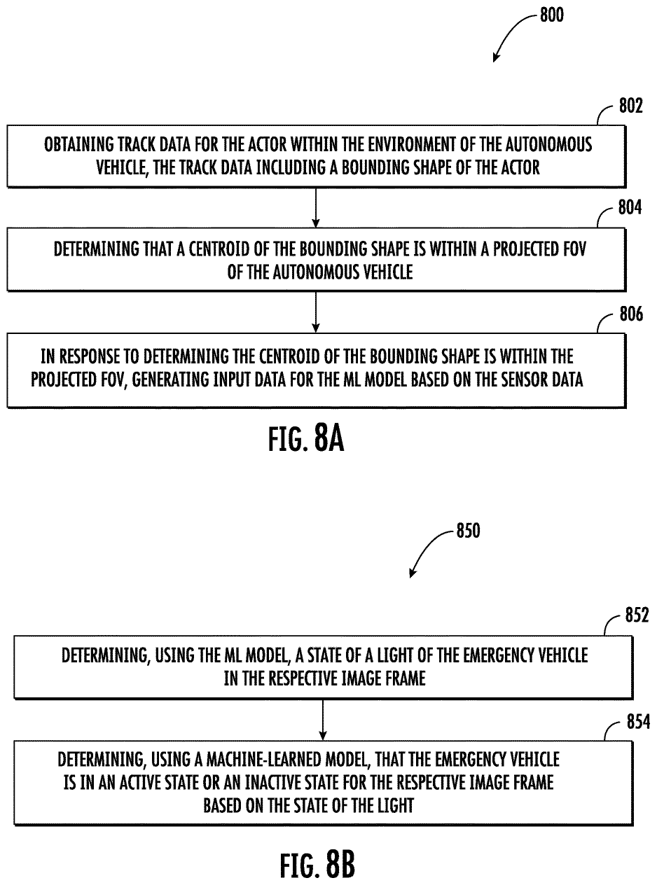

In some example, the first image frame can be pre-processed to according to method 800 of FIG. 8A. At 802, the method 800 includes obtaining track data for a first actor within the environment the autonomous vehicle (e.g., depicted in the first image frame). The track data can be indicative of a bounding shape of the first actor. At 804, the method 800 includes determining that a centroid of the bounding shape is within a projected field of view of the autonomous vehicle. At 806, in response to determining the centroid of the bounding shape is within the projected field of view, method 800 includes generating input data for the emergency vehicle model based on the sensor data. The input data can include a cropped version of the first image frame depicting the first actor.

Returning to FIG. 7, at 706, the method 700 includes, for the respective image frame, generating, using the machine-learned model, output data indicating that the emergency vehicle is in an active state or an inactive state in the respective image frame. As described herein, the emergency vehicle model can process the first image frame to determine that the first actor depicted in the first image frame is a first emergency vehicle such as a police car.

The emergency vehicle model can determine whether the first emergency vehicle is in an active state or inactive state. To do so, method 850 of FIG. 8B can be used.

At 852, method 850 includes determining, using the machine-learned model, a state of a light of the first emergency vehicle in the respective image frame, wherein the state of the light includes an on state or an off state. As described herein, in some examples, this includes the emergency vehicle model analyzing the pixels of the first image frame to determine whether one or more characteristics (e.g., brightness, color, etc.) of a first light of the first emergency vehicle are indicative of an illuminated lighting element. By way of example, the emergency vehicle model can determine that a roof mounted light of a police car is illuminated blue in the first image frame.

At 854, the method 850 includes determining, using the machine-learned model, that the emergency vehicle is in the active state or the inactive state for the respective image frame based on the state of the light. In the event that the emergency vehicle model detects an on state (e.g., illuminated blue light), the first emergency vehicle can be considered to be in an active state. In the event that the emergency vehicle model detects an off state, the first emergency vehicle can be considered to be in an inactive state.

Returning to FIG. 7, the method 700 can include storing attribute data for the respective image frame. The attribute data can include the output data of the machine-learned model and a time associated with the respective image frame. In an example, at 708, the method 700 includes storing, in a buffer, attribute data for the respective image frame, the attribute data including the output data of the machine-learned model and a time associated with the respective image frame. This can include the first image frame with a probability that the first emergency vehicle is an active emergency vehicle associated with a time (e.g., when the first image frame was captured), and a track of the first emergency vehicle.

The method 700 can include determining, based on the output data associated with the respective image frame, that the emergency vehicle is an active emergency vehicle. In an example, at 710, the method 700 includes determining that the buffer includes a threshold amount of attribute data for a plurality of image frames at a plurality of times. For instance, the buffer can store, as attribute data, a plurality of second image frames as they are processed and outputted by the emergency vehicle model. Each of the second image frames being stored with an indication as to whether the first emergency vehicle is active or inactive, an associated time, and a track. Once the buffer includes the threshold number of processed image frames for the first emergency vehicle, covering a threshold plurality of time frames, a second model can process at least a subset of the image frames.

At 712, the method 700 includes determining, using a second model, that the emergency vehicle is an active emergency vehicle based on the attribute data for at least a subset of the plurality of image frames. As described herein, the second model can include a downstream smoother model configured to confirm the presence of an active emergency vehicle in the environment by analyzing the outputs of the machine-learned emergency vehicle model over a plurality of times for the given subset. By way of example, the smoother model can determine that greater than 50% of the first and second image frames indicate that the depicted police car is active. Thus, the smoother model can output, to one or more of the systems onboard the autonomous vehicle, data indicating that the first actor is an active emergency vehicle.

At 714, the method 700 includes performing an action for the autonomous vehicle based on the active emergency vehicle being within the environment of the autonomous vehicle. This can include, for example, at least one of: (1) forecasting a motion of the active emergency vehicle; (2) generating a motion plan for the autonomous vehicle; or (3) controlling a motion of the autonomous vehicle, as described herein.

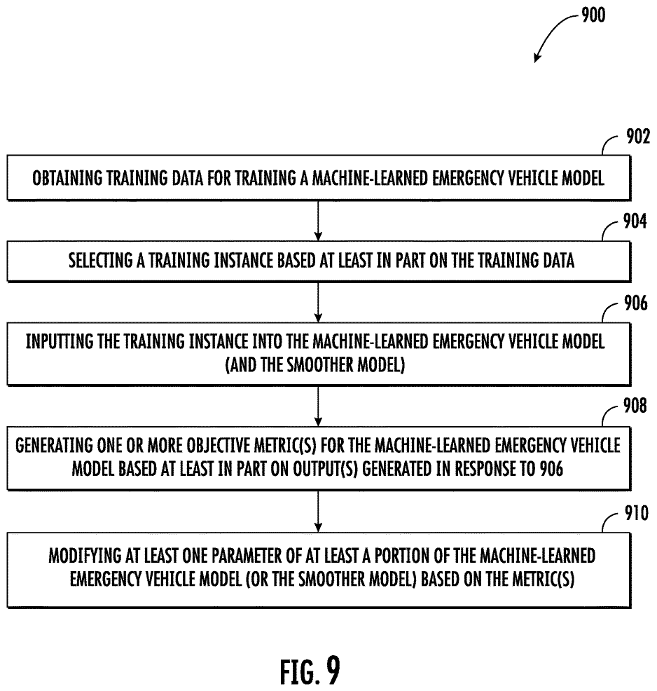

FIG. 9 depicts a flowchart of a method 900 for training one or more models according to aspects of the present disclosure. For instance, a model can include an emergency vehicle model or a smoother model, as described herein.

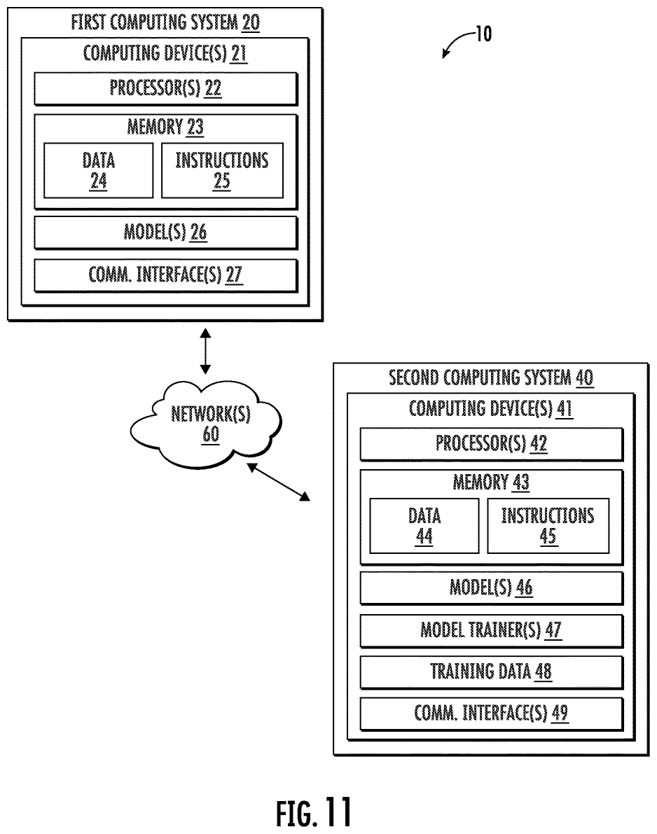

One or more portion(s) of the method 900 can be implemented by a computing system that includes one or more computing devices such as, for example, the computing systems described with reference to the other figures (e.g., a system of FIG. 11, etc.). Each respective portion of the method 900 can be performed by any (or any combination) of one or more computing devices. Moreover, one or more portion(s) of the method 900 can be implemented on the hardware components of the device(s) described herein (e.g., as in FIG. 11, etc.), for example, to train an example model of the present disclosure.

FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 9 is described with reference to elements/terms described with respect to other systems and figures for exemplary illustrated purposes and is not meant to be limiting. One or more portions of method 900 can be performed additionally, or alternatively, by other systems.

At 902, the method 900 can include obtaining training data for the machine-learned emergency vehicle model. The training data can include sensor data, perception output data, log data, simulation data, etc. The training data can include vehicle state data, tracks, image frames captured during instances of real-world or simulated driving, associated times in which the actors/objects in the environments were perceived by an autonomous vehicle, and other information.

For instance, sensor data, which can be used as a basis for training data, can be collected using one or more autonomous platforms (e.g., autonomous platform 110) or the sensors thereof as the autonomous platform is within its environment. By way of example, the training data can be collected using one or more autonomous vehicle(s) or sensors thereof as the vehicles operate along one or more travel ways. In some example methods, the training data can be collected using other sensors, such as mobile-device-based sensors, ground-based sensors, aerial-based sensors, satellite-based sensors, or substantially any sensor interface configured for obtaining and/or recording measured data. In some example methods, training data can be collected from public sources that are non-specific to emergency vehicles. For instance, training data can be collected from emergency vehicle-specific channels or other publicly available online sources.

Perception output data can include data that is output from a perception system of an autonomous vehicle. In some example, the perception output data can include certain metadata that is produced by the perception system (or the functions thereof). For instance, perception output data can include metadata associated to characteristics of objects/actors in image frames captured of an environment. In some example methods, perception output data can include vehicle tracks. The tracks can include a bounding shape of the actor and state data. State data can include the position, velocity, acceleration, etc. of an actor at the time at which the actor was perceived.

Log data can include data that is obtained from one or more autonomous vehicles and downloaded to an offline system. The log data can be logged versions of sensor data, perception output data, etc. The log data can be stored in an accessible memory and can be extracted to produced specific combinations of attributes for training data.

In some examples, the training data can include simulated data. The simulated data can be collected during one or more simulation instances/runs. The simulation instances can simulate a scenario in which a simulated autonomous vehicle traverses a simulated environment and captures simulated perception output data of the simulated environment. Simulated emergency vehicles as well as non-emergency vehicles can be placed within the scenario such that the resultant simulated log data is reflective of the simulated perception output data. In this way, simulated log data can include emergency vehicles and non-emergency vehicles, which can then be used for training data generation.

The training data can cover vehicles and emergency vehicles from different aspects. For example, training data can cover numerous non-emergency vehicle types and appearances. Training data can be biased towards close range emergency vehicles that are easy to classify. Training data can cover rich scenes involving emergency vehicles including day and night, highway and urban environments, and various other traffic conditions.

In some examples, the training data can include augmented training data. Data augmentation can be applied to training data by applying transformations on raw image data with cropping, flipping, rotation, resizing, color jitting, etc. Data augmentation can include tweaking the vehicle track bounding shape in a statistical way by sampling a state distribution to generate a new track bounding shape. For instance, training data can contain the track's state coordinates x, y, z of the bounding shape center and the length, width, and height of the bounding shape. The track's state can fit a sampled multivariate normal distribution and such changes can affect the image cropping positions to augment the dataset. Augmented training data can ensure the augmented data set is natural and very likely to occur in the real world. In some example methods, augmented training data can use a sampling ratio multiplier on positive targets and negative targets.

In some example methods, training data can be processed by a data engine. The data engine can be used to mine data (e.g., log data) to find events of positive emergency vehicle detections. In some examples, the positive emergency vehicle events can be added to the training data set for further training of the emergency vehicle model. In some example methods, false positive emergency vehicle events can be added to the training data set for further training. For instance, a false positive event rate can be measured for improvement and change in recall comparative to a baseline.

The training data can include labelled training data. For instance, the training data can include label data indicating that an actor in a respective image frame is an emergency vehicle or a non-emergency vehicle, a type of vehicle, an activeness (e.g., indicating active state or inactive state), bulb/light state, etc. In some examples, the training data can include labels that indicate that a variety of other details (e.g. bulb color, bulb intensity, etc.) about a light of a vehicle in a respective image frame.

Labelling can include four-dimensional (4D) labeling (e.g., 3D bounding box around the lidar points on the object, as a function of time) and two-dimensional (2D) labeling (e.g., 2D bounding box on the object within the forward camera image). The 4D and 2D labels can be associated and used to generate a sequence of images (e.g., a collage video) of each individual actor. Actor metadata can also be tagged including vehicle type, bulb state, activeness, etc.

If an actor is labeled as an emergency vehicle, a second labeling stage for activeness and bulb state can be initiated. For instance, at each time frame of the sequence (e.g., of the collage video), the image frame can be labelled as active if the beacon/bulb light is flashing and labelled as inactive otherwise. Active image frames can be labelled as “bulb on” or “on state” if the light is illuminated and “bulb off” or “off state,” otherwise. The activeness labeling can rely on the temporal context, while the bulb state labeling can rely on each single frame.

Data extraction for training purposes can be similar to the online implemented cropping and filtering. For example, a data engine can mine log data to find two-dimensional data (2D) labels linked to a given four-dimensional (4D) label and extract data regarding emergency vehicles, bulb states (e.g., blub-on being positive, bub-off being negative), non-active emergency vehicles, non-emergency vehicles, or other information.

Table 1 provides a summary of an example training dataset distribution.

TABLE 1

| Category | Distribution |
|---|---|
| Vehicle type | EV: 3.4%, non-EV: 96.6% |
| EV type | police vehicle: 80.0%, fire vehicle: 13.4%, |
| | ambulance: 6.6% |
| EV activeness | active: 90.0%, inactive: 10.0% |
| Bulb state of active EVs | bulb-on: 91.8%, bulb-off: 8.2% |

The training data can include a plurality of training sequences divided between multiple datasets (e.g., a training dataset, a validation dataset, or testing dataset). Each training sequence can include a plurality of pre-recorded perception datapoints, point clouds, images, etc.

At 904, the method 900 includes selecting a training instance based on the training data. For instance, a model trainer can select a labelled training dataset to train the machine-learned emergency vehicle model. This labelled training data can include actors or scenarios that will be commonly viewed by the emergency vehicle model or edge cases for which the model should be trained.

Training instances can also be selected based on certain targets. Targets can include true positive and false positive targets. This can help improve the model irrespective of whether they were true positive or false positive events. For instance, targets can include positive targets which can indicate an active emergency vehicle. In some example methods, targets can include negative targets which can indicate an inactive emergency vehicle. In some examples, a negative target can include non-emergency vehicles.

Targets can include positive and negative targets in a variety of contexts including day and night, highway and urban, and various other traffic conditions. In some examples, targets can be generated from real-world or simulated driving. In some example methods, targets can be generated from public sources that are non-specific to emergency vehicles.

At 906, the method 900 can include inputting the training instance into the machine-learned emergency vehicle model. For example, the machine-learned model can receive the training data and extract labels to determine positive and negative emergency vehicle detections. The machine-learned model can process the training data and generate machine-learned output data. In some examples, the machine-learned output data can include a baseline. In some examples, the machine-learned output data can include oversampling within a training set.

The smoother model can also be evaluated for a given training instance. For example, the output data produced from training the machine-learned emergency vehicle model can include image frames (at a plurality of times) with indicators for emergency vehicles and activeness state. This can be input into the smoother model, which can output a final training determination of whether an emergency vehicle is active based on analyzing a plurality of training image frames across a plurality of times.

At 908, the method 900 can include generating one or more loss metrics or one or more objectives for the machine-learned emergency model based on outputs of at least a portion of the model and labels associated with the training instances. For example, the output can be compared to the training data to determine the progress of the training and the precision of the model.

At 910, the method 900 can include modifying at least one parameter of at least a portion of the machine-learned emergency vehicle model based on the loss metrics or at least one of the objectives. For example, a computing system can modify at least one hyperparameter of the machine-learned emergency vehicle model. The hyperparameters of the emergency vehicle model can be tuned to improve the max-F1 score or other metrics. The data engine can continuously improve the model by adding more and more data over time during training and retraining.

In some examples, the down-stream smoother model can also be refined and evaluated with system-level metrics. For instance, since the smoother model can aim to determine whether a vehicle is an emergency vehicle in an active state (e.g., flashing light), the activeness label can be used to compare with the outputs to calculate metrics. As the emergency vehicle model is trained, the smoother model's supermajority threshold can be updated by, for example, refining the minimum fraction of positive outputs in the buffer to output a final positive active emergency vehicle detection. This can be done by evaluating recall, F1 scores, and tracking the level of false negatives. Example smoother results are provided in Table 3.

TABLE 3

| | % change of | % change of | % change of |
|---|---|---|---|
| Smoother supermajority | F1 score | precision | recall |
| Smoother threshold = 0.0 | 0.0 | 0.0 | 0.0 |
| Smoother threshold = 0.3 | 5.07 | 10.30 | −0.68 |
| Smoother threshold = 0.5 | 4.87 | 9.87 | −0.51 |
| Smoother threshold = 0.7 | −7.02 | 6.80 | −20.0 |

In some example methods, the machine-learned emergency vehicle model can be trained in an end-to-end manner. For example, in some implementations, the machine-learned emergency vehicle model can be fully differentiable.

After being updated, the emergency vehicle model or the operational system including the model can be provided for validation. In some implementations, the smoother model can evaluate or validate the operational system to identify areas of performance deficits as compared to a corpus of exemplars. The smoother model can trigger retraining, decommissioning, etc. of the operational system based on, for example, failure to satisfy a validation threshold in one or more areas.

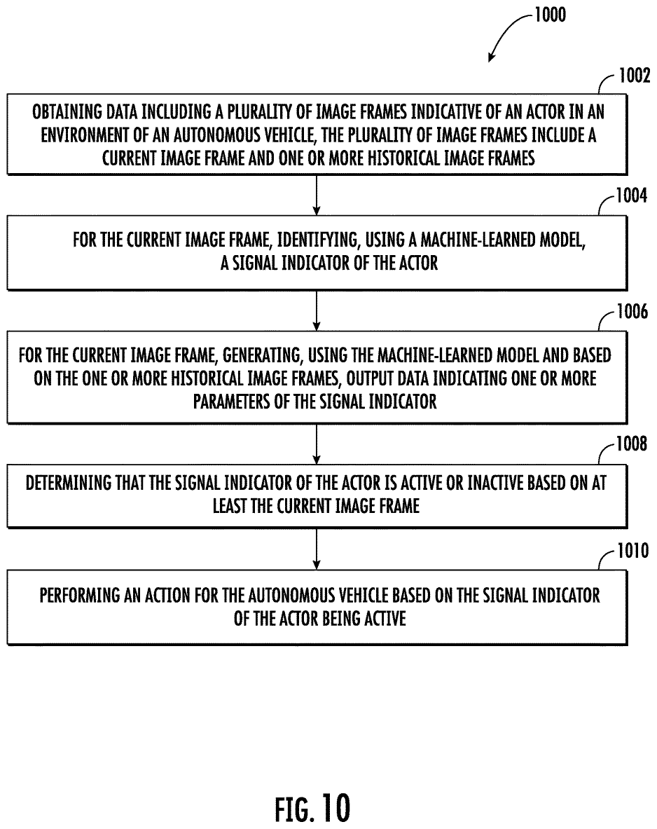

FIG. 10 depicts a flowchart of a method 1000 for detecting signal indicator states and controlling the autonomous vehicle according to aspects of the present disclosure. One or more portion(s) of the method 1000 can be implemented by a computing system that includes one or more computing devices such as, for example, the computing systems described with reference to the other figures. Each respective portion of the method 1000 can be performed by any (or any combination) of one or more computing devices. Moreover, one or more portion(s) of the method 1000 can be implemented on the hardware components of the device(s) described herein, for example, to detect and determine the state of a signal indicator.

FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of method 1000 can be performed additionally, or alternatively, by other systems.

At 1002, the method 1000 can include obtaining data including a plurality of image frames indicative of an actor in an environment of an autonomous vehicle. For instance, a computing system (e.g., the onboard computing system of the autonomous vehicle) can obtain data indicative of the plurality of image frames that include a current image frame and one or more historical image frames. As described herein, the current image frame can be associated with a current timestep t, while the historical image frames can be associated with past time steps t−1, t−2, etc. The image frames can be RBG image frames captured via a camera onboard the autonomous vehicle.

At 1004, the method 1000 can include, for the current image frame, identifying, using a machine-learned model, a signal indicator of the actor. As described herein, a computing system can utilize a machine-learned signal indicator model to determine that a signal indicator is depicted in an image crop of the current image frame. The signal indicator can be a turn signal, hazard signal, brake signal, etc. The signal indicator model can determine the type, position, color, etc. of the signal indicator.

At 1006, the method 1000 can include, for the current image frame, generating, using the machine-learned model and based on the one or more historical image frames, output data indicating one or more characteristics of the signal indicator. For instance, the signal indicator model can process the current image frame with the embeddings of historical image frames (at previous time steps). As described herein, this can allow the signal indicator model to concatenate this data to inform its analysis of the state of the signal indicator in the current image frame. For example, the signal indicator model can process the frames across the multiple time steps to recognize that a right turn signal light of a vehicle is illuminated in a flashing pattern across the timesteps, including the current time step. Thus, the state of the signal indicator for the current image frame (at the current time step) can be an active state of the right turn signal light.

At 1008, the method 1000 can include determining that the signal indicator of the actor is active or inactive based on at least the current image frame. This can include storing the output data of the signal indicator model as attribute data. The attribute data can indicate the model's determination of signal indicator states for each image frame across a plurality of time steps. As described herein, the states can be evaluated to determine that the actor's signal indicator (e.g., its right turn signal) is active/on.

At 1010, the method 1000 can include performing an action for the autonomous vehicle based on the signal indicator of the actor being active. As described herein, this can include determining the intention of the actor (e.g., with an intention model), forecasting actor motion, generating motion plans/trajectories for the autonomous vehicle, controlling the autonomous vehicle, etc. These actions can be performed to avoid interfering with the actor.

FIG. 11 is a block diagram of an example computing ecosystem 10 according to example implementations of the present disclosure. The example computing ecosystem 10 can include a first computing system 20 and a second computing system 40 that are communicatively coupled over one or more networks 60. In some implementations, the first computing system 20 or the second computing 40 can implement one or more of the systems, operations, or functionalities described herein for validating one or more systems or operational systems (e.g., the remote system(s) 160, the onboard computing system(s) 180, the autonomy system(s) 200, etc.).

In some implementations, the first computing system 20 can be included in an autonomous platform and be utilized to perform the functions of an autonomous platform as described herein. For example, the first computing system 20 can be located onboard an autonomous vehicle and implement autonomy system(s) for autonomously operating the autonomous vehicle. In some implementations, the first computing system 20 can represent the entire onboard computing system or a portion thereof (e.g., the localization system 230, the perception system 240, the planning system 250, the control system 260, detection system 407, or a combination thereof, etc.). In other implementations, the first computing system 20 may not be located onboard an autonomous platform. The first computing system 20 can include one or more distinct physical computing devices 21.

The first computing system 20 (e.g., the computing device(s) 21 thereof) can include one or more processors 22 and a memory 23. The one or more processors 22 can be any suitable processing device (e.g., a processor core, a microprocessor, an ASIC, a FPGA, a controller, a microcontroller, etc.) and can be one processor or a plurality of processors that are operatively connected. The memory 23 can include one or more non-transitory computer-readable storage media, such as RAM, ROM, EEPROM, EPROM, one or more memory devices, flash memory devices, etc., and combinations thereof.

The memory 23 can store information that can be accessed by the one or more processors 22. For instance, the memory 23 (e.g., one or more non-transitory computer-readable storage media, memory devices, etc.) can store data 24 that can be obtained (e.g., received, accessed, written, manipulated, created, generated, stored, pulled, downloaded, etc.). The data 24 can include, for instance, sensor data, map data, data associated with autonomy functions (e.g., data associated with the perception, planning, or control functions), simulation data, or any data or information described herein. In some implementations, the first computing system 20 can obtain data from one or more memory device(s) that are remote from the first computing system 20.

The memory 23 can store computer-readable instructions 25 that can be executed by the one or more processors 22. The instructions 25 can be software written in any suitable programming language or can be implemented in hardware. Additionally, or alternatively, the instructions 25 can be executed in logically or virtually separate threads on the processor(s) 22.

For example, the memory 23 can store instructions 25 that are executable by one or more processors (e.g., by the one or more processors 22, by one or more other processors, etc.) to perform (e.g., with the computing device(s) 21, the first computing system 20, or other system(s) having processors executing the instructions) any of the operations, functions, or methods/processes (or portions thereof) described herein. For example, operations can include implementing system validation (e.g., as described herein).

In some implementations, the first computing system 20 can store or include one or more models 26. In some implementations, the models 26 can be or can otherwise include one or more machine-learned models (e.g., a machine-learned emergency vehicle detection model, a machine-learned operational system, etc.). As examples, the models 26 can be or can otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the first computing system 20 can include one or more models for implementing subsystems of the autonomy system(s) 200, including any of: the localization system 230, the perception system 240, the planning system 250, or the control system 260.

In some implementations, the first computing system 20 can obtain the one or more models 26 using communication interface(s) 27 to communicate with the second computing system 40 over the network(s) 60. For instance, the first computing system 20 can store the model(s) 26 (e.g., one or more machine-learned models) in the memory 23. The first computing system 20 can then use or otherwise implement the models 26 (e.g., by the processors 22). By way of example, the first computing system 20 can implement the model(s) 26 to localize an autonomous platform in an environment, perceive an autonomous platform's environment or objects therein, plan one or more future states of an autonomous platform for moving through an environment, control an autonomous platform for interacting with an environment, detect an emergency vehicle, etc.

The second computing system 40 can include one or more computing devices 41. The second computing system 40 can include one or more processors 42 and a memory 43. The one or more processors 42 can be any suitable processing device (e.g., a processor core, a microprocessor, an ASIC, a FPGA, a controller, a microcontroller, etc.) and can be one processor or a plurality of processors that are operatively connected. The memory 43 can include one or more non-transitory computer-readable storage media, such as RAM, ROM, EEPROM, EPROM, one or more memory devices, flash memory devices, etc., and combinations thereof.

The memory 43 can store information that can be accessed by the one or more processors 42. For instance, the memory 43 (e.g., one or more non-transitory computer-readable storage media, memory devices, etc.) can store data 44 that can be obtained. The data 44 can include, for instance, sensor data, model parameters, map data, simulation data, simulated environmental scenes, simulated sensor data, data associated with vehicle trips/services, or any data or information described herein. In some implementations, the second computing system 40 can obtain data from one or more memory device(s) that are remote from the second computing system 40.

The memory 43 can also store computer-readable instructions 45 that can be executed by the one or more processors 42. The instructions 45 can be software written in any suitable programming language or can be implemented in hardware. Additionally, or alternatively, the instructions 45 can be executed in logically or virtually separate threads on the processor(s) 42.

For example, the memory 43 can store instructions 45 that are executable (e.g., by the one or more processors 42, by the one or more processors 22, by one or more other processors, etc.) to perform (e.g., with the computing device(s) 41, the second computing system 40, or other system(s) having processors for executing the instructions, such as computing device(s) 21 or the first computing system 20) any of the operations, functions, or methods/processes described herein. This can include, for example, the functionality of the autonomy system(s) 200 (e.g., localization, perception, planning, control, etc.) or other functionality associated with an autonomous platform (e.g., remote assistance, mapping, fleet management, trip/service assignment and matching, etc.). This can also include, for example, validating a machined-learned operational system.

In some implementations, the second computing system 40 can include one or more server computing devices. In the event that the second computing system 40 includes multiple server computing devices, such server computing devices can operate according to various computing architectures, including, for example, sequential computing architectures, parallel computing architectures, or some combination thereof.

Additionally, or alternatively to, the model(s) 26 at the first computing system 20, the second computing system 40 can include one or more models 46. As examples, the model(s) 46 can be or can otherwise include various machine-learned models (e.g., a machine-learned operational system, etc.) such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the second computing system 40 can include one or more models of the autonomy system(s) 200.

In some implementations, the second computing system 40 or the first computing system 20 can train one or more machine-learned models of the model(s) 26 or the model(s) 46 through the use of one or more model trainers 47 and training data 48. The model trainer(s) 47 can train any one of the model(s) 26 or the model(s) 46 using one or more training or learning algorithms. One example training technique is backwards propagation of errors. In some implementations, the model trainer(s) 47 can perform supervised training techniques using labeled training data. In other implementations, the model trainer(s) 47 can perform unsupervised training techniques using unlabeled training data. In some implementations, the training data 48 can include simulated training data (e.g., training data obtained from simulated scenarios, inputs, configurations, environments, etc.). In some implementations, the second computing system 40 can implement simulations for obtaining the training data 48 or for implementing the model trainer(s) 47 for training or testing the model(s) 26 or the model(s) 46. By way of example, the model trainer(s) 47 can train one or more components of a machine-learned model for the autonomy system(s) 200 through unsupervised training techniques using an objective function (e.g., costs, rewards, heuristics, constraints, etc.). In some implementations, the model trainer(s) 47 can perform a number of generalization techniques to improve the generalization capability of the model(s) being trained. Generalization techniques include weight decays, dropouts, or other techniques.

For example, in some implementations, the second computing system 40 can generate training data 48 according to example aspects of the present disclosure. For instance, the second computing system 40 can generate training data 48. For instance, the second computing system 40 can implement methods according to example aspects of the present disclosure. The second computing system 40 can use the training data 48 to train model(s) 26. For example, in some implementations, the first computing system 20 can include a computing system onboard or otherwise associated with a real or simulated autonomous vehicle. In some implementations, model(s) 26 can include perception or machine vision model(s) configured for deployment onboard or in service of a real or simulated autonomous vehicle. In this manner, for instance, the second computing system 40 can provide a training pipeline for training model(s) 26.

The first computing system 20 and the second computing system 40 can each include communication interfaces 27 and 49, respectively. The communication interfaces 27, 49 can be used to communicate with each other or one or more other systems or devices, including systems or devices that are remotely located from the first computing system 20 or the second computing system 40. The communication interfaces 27, 49 can include any circuits, components, software, etc, for communicating with one or more networks (e.g., the network(s) 60). In some implementations, the communication interfaces 27, 49 can include, for example, one or more of a communications controller, receiver, transceiver, transmitter, port, conductors, software or hardware for communicating data.

The network(s) 60 can be any type of network or combination of networks that allows for communication between devices. In some implementations, the network(s) can include one or more of a local area network, wide area network, the Internet, secure network, cellular network, mesh network, peer-to-peer communication link or some combination thereof and can include any number of wired or wireless links. Communication over the network(s) 60 can be accomplished, for instance, through a network interface using any type of protocol, protection scheme, encoding, format, packaging, etc.

FIG. 11 illustrates one example computing ecosystem 10 that can be used to implement the present disclosure. Other systems can be used as well. For example, in some implementations, the first computing system 20 can include the model trainer(s) 47 and the training data 48. In such implementations, the model(s) 26, 46 can be both trained and used locally at the first computing system 20. As another example, in some implementations, the computing system 20 may not be connected to other computing systems. Additionally, components illustrated or discussed as being included in one of the computing systems 20 or 40 can instead be included in another one of the computing systems 20 or 40.

Computing tasks discussed herein as being performed at computing device(s) remote from the autonomous platform (e.g., autonomous vehicle) can instead be performed at the autonomous platform (e.g., via a vehicle computing system of the autonomous vehicle), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks or operations can be performed sequentially or in parallel. Data and instructions can be stored in a single memory device or across multiple memory devices.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. can be used to illustrate operations. Such identifiers are provided for the ease of the reader and do not denote a particular order of steps or operations. An operation illustrated by a list identifier of (a), (i), etc. can be performed before, after, or in parallel with another operation illustrated by a list identifier of (b), (ii), etc.

1.-20. (canceled)

21. A computer-implemented method comprising:
(a) obtaining sensor data comprising a plurality of image frames indicative of an actor in an environment of an autonomous vehicle;
(b) for a respective image frame,
(i) determining, using a machine-learned model, that the actor is an emergency vehicle,
(ii) generating, using the machine-learned model, output data indicating that the emergency vehicle is in an active state or an inactive state in the respective image frame, and
(iii) storing attribute data for the respective image frame, the attribute data comprising the output data of the machine-learned model and a time associated with the respective image frame;
(c) determining, based on the output data associated with the respective image frame, that the emergency vehicle is an active emergency vehicle; and
(d) performing an action for the autonomous vehicle based on the active emergency vehicle being within the environment of the autonomous vehicle.

22. The computer-implemented method of claim 21, wherein (b)(ii) comprises:
determining, using the machine-learned model, a state of a light of the emergency vehicle in the respective image frame, wherein the state of the light comprises an on state or an off state; and
determining, using the machine-learned model, that the emergency vehicle is in the active state or the inactive state for the respective image frame based on the state of the light.

23. The computer-implemented method of claim 21, wherein (b)(i) comprises:
determining, using the machine-learned model, a category of the emergency vehicle from among one of the following categories: (1) a police car; (2) an ambulance; (3) a fire truck; or (4) a tow truck.

24. The computer-implemented method of claim 21, wherein the output data is indicative of a category of the emergency vehicle.

25. The computer-implemented method of claim 21, wherein (b)(i) comprises:
obtaining track data for the actor within the environment the autonomous vehicle, the track data being indicative of a bounding shape of the actor;
determining that a centroid of the bounding shape is within a projected field of view of the autonomous vehicle; and
in response to determining the centroid of the bounding shape is within the projected field of view, generating input data for the machine-learned model based on the sensor data.

26. The computer-implemented method of claim 21, wherein the output data further comprises track data associated with the emergency vehicle.

27. The computer-implemented method of claim 21, wherein (b)(iii) comprises storing the attribute data in a buffer, and wherein the computer-implemented method further comprises:
determining that the buffer comprises a threshold amount of attribute data for a plurality of image frames at a plurality of times; and
determining, using a second model, that the emergency vehicle is an active emergency vehicle based on the attribute data for at least a subset of the plurality of image frames.

28. The computer-implemented method of claim 27, wherein (c) comprises:
determining, using the second model, at least one of the following: (1) a pattern of a light of the emergency vehicle; (2) a color of the light of the emergency vehicle; or (3) an intensity of the light of the emergency vehicle.

29. The computer-implemented method of claim 27, wherein the second model is a rules-based smoothing model.

30. The computer-implemented method of claim 27, wherein (b)(iii) comprises storing, in a buffer, the attribute data for the respective image frame, the attribute data comprising the output data of the machine-learned model and the time associated with the respective image frame, and
wherein (c) comprises determining that the buffer comprises the threshold amount of attribute data for the plurality of image frames at the plurality of times.

31. The computer-implemented method of claim 21, wherein the machine-learned model is trained based on labeled training data, wherein the labeled training data is based on point cloud data and image data, and wherein the labeled training data is indicative of a plurality of training actors, a respective training actor being labelled with an emergency vehicle label.

32. The computer-implemented method of claim 31, wherein the emergency vehicle label indicates a type of emergency vehicle of the respective training actor or that the training actor is not an emergency vehicle.

33. The computer-implemented method of claim 31, wherein the respective training actor comprises an activity label indicating that the respective training actor is in an active state or an inactive state based on a light of the training actor.

34. The computer-implemented method of claim 21, wherein the machine-learned model is a convolutional neural network.

35. The computer-implemented method of claim 21, wherein the action by the autonomous vehicle comprises at least one of: (1) forecasting a motion of the active emergency vehicle; (2) generating a motion plan for the autonomous vehicle; or (3) controlling a motion of the autonomous vehicle.

36. The computer-implemented method of claim 21, wherein the machine-learned model is further configured to process one or more historical image frames to generate the output data, the one or more historical image frames being associated with one or more timesteps that are previous to a timestep associated with the respective time frame.

37. One or more non-transitory computer-readable media storing instructions that are executable to cause one or more processors to perform operations, the operations comprising:
(a) obtaining sensor data comprising a plurality of image frames indicative of an actor in an environment of an autonomous vehicle;
(b) for a respective image frame,
(i) determining, using a machine-learned model, that the actor is an emergency vehicle,
(ii) generating, using the machine-learned model, output data indicating that the emergency vehicle is in an active state or an inactive state in the respective image frame, and
(iii) storing attribute data for the respective image frame, the attribute data comprising the output data of the machine-learned model and a time associated with the respective image frame;
(c) determining, based on the output data associated with the respective image frame, that the emergency vehicle is an active emergency vehicle; and
(d) performing an action for the autonomous vehicle based on the active emergency vehicle being within the environment of the autonomous vehicle.

38. The one or more non-transitory computer-readable media of claim 37, wherein (b)(ii) comprises:
determining, using the machine-learned model, a state of a light of the emergency vehicle in the respective image frame, wherein the state of the light comprises an on state or an off state; and
determining, using the machine-learned model, that the emergency vehicle is in the active state or the inactive state for the respective image frame based on the state of the light.

39. The one or more non-transitory computer-readable media of claim 37, wherein the output data is indicative of a category of the emergency vehicle.

40. The one or more non-transitory computer-readable media of claim 37, wherein (b)(i) comprises:
obtaining track data for the actor within the environment of the autonomous vehicle, the track data being indicative of a bounding shape of the actor;
determining that a centroid of the bounding shape is within a projected field of view of the autonomous vehicle; and
in response to determining the centroid of the bounding shape is within the projected field of view, generating input data for the machine-learned model based on the sensor data.
